(19) United States
(12) Patent Application Publication
(10) Pub. No.: US 2023/0184663 A1
(43) Pub. Date: Jun. 15, 2023

(54) DEVICES, SYSTEMS, AND METHODS FOR DEBUBBLING

(71) Applicant: 10x Genomics, Inc., Pleasanton, CA (US)

(72) Inventors: Siyuan XING, Newark, CA (US); William STANISLAUS, Fremont, CA (US); Yiran ZHANG, Castro Valley, CA (US)

(21) Appl. No.: 18/066,104

(22) Filed: Dec. 14, 2022

Related U.S. Application Data
(60) Provisional application No. 63/289,795, filed on Dec. 15, 2021.

(51) Int. Cl. G01N 15/14; B01L 3/00

(52) U.S. Cl. CPC G01N 15/1404; B01L 3/502723; B01L 2300/0663; B01L 2300/0654; B01L 2400/0622; B01L 2200/0684; B01L 2200/16; G01N 2015/1068

(57) ABSTRACT

Devices, systems, and methods for reducing the introduction of bubbles to flow cells and removing existing bubbles from flow cells are provided. The devices, systems, and methods detect and redirect bubbles away from the flow cell before the bubble reaches the inlet or wash away bubbles from within the flow cell.

### BACKGROUND

Many biological and biophysical assays require contacting biological samples with one or more fluids containing reagents. For example, sequencing and imaging assays both require contacting a sample with one or more reagents. These samples can be contained within a closed flow cell. During fluid exchange for the assays, bubbles may be introduced into the closed flow cells and may interfere with reactions by preventing or reducing contact of reagents and samples and/or introduce imaging artifacts.

New devices, systems, and methods for reducing the introduction of bubbles to flow cells and removing existing bubbles from flow cells would be helpful.

### BRIEF SUMMARY

In general, the present disclosure relates to devices, methods, and systems for reducing the introduction of bubbles to flow cells and removing existing bubbles from flow cells, e.g., by fluidically directing bubbles away from the flow cell or flushing flow cells having one or more bubbles with a washing liquid.

In one aspect, devices are disclosed for reducing (e.g., reducing by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells. The device includes (i) a flow cell inlet connection, (ii) a flow cell outlet connection, (iii) a flow cell inlet channel, (iv) a flow cell outlet channel, (v) a first sensor, (vi) a second sensor, (vii) a first fluidic switch, and (viii) a bypass channel, wherein the first fluidic switch directs flow from the flow cell inlet channel into either the flow cell inlet connection or the bypass channel, the flow cell outlet connection is in fluid communication with the flow cell outlet channel, the first sensor is disposed to detect a bubble upstream of the first fluidic switch, and the second sensor is disposed to detect the bubble in the bypass channel. In some embodiments, the bypass channel is passively or actively in fluid communication with the flow cell outlet channel. In some embodiments, devices described herein further include a second fluidic switch that directs flow from the flow cell outlet connection or the bypass channel into the flow cell outlet channel. In some embodiments, devices described herein further include a waste channel or reservoir in fluid communication with the bypass channel.

In some embodiments, the first and second sensors are optical sensors.

In some embodiments, devices described herein further include a flow cell having an inlet in fluid communication with the flow cell inlet connection and an outlet in fluid communication with the flow cell outlet connection.

In one aspect, systems are disclosed for reducing (e.g., reducing by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells. In some embodiments, the system includes a flow cell. In some embodiments, the system further includes a flow cell having an inlet in fluid communication with the flow cell inlet connection and an outlet in fluid communication with the flow cell outlet connection. The system includes any device described herein and a fluidic pump disposed to pump liquid in the flow cell. In some embodiments, systems described herein further include a reagent reservoir in fluid communication with the first channel.

In some embodiments, systems described herein further include a switch controller for controlling the first and/or second fluidic switches. In some embodiments the switch controller is configured to receive input from the first and second sensors.

In some embodiments, systems described herein further include a pump controller for controlling the fluidic pump.

In some embodiments, systems described herein further include an imaging device or imaging system disposed to image a flow cell.

In some embodiments, the flow cell of systems described herein includes a sample. In some embodiments, an imaging device or imaging system is disposed to image the sample.

In one aspect, systems are disclosed for reducing (e.g., reducing by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells. The system includes (a) a device including: (i) a flow cell inlet connection, (ii) a flow cell outlet connection, (iii) a flow cell inlet channel, (iv) a flow cell outlet channel, (v) a first sensor, (vi) a second sensor, (vii) a first fluidic switch, and (viii) a bypass channel, wherein the first fluidic switch directs flow from the flow cell inlet channel into either the flow cell inlet connection or the bypass channel, the flow cell outlet connection is in fluid communication with the flow cell outlet channel, the first sensor is disposed to detect a bubble upstream of the first fluidic switch, and the second sensor is disposed to detect the bubble in the bypass channel; and (b) a switch controller for controlling the first switch. The switch controller is configured to receive an input from the first sensor, whereby upon detection of a bubble by the first sensor, the switch controller actuates the first fluidic switch to place the flow cell inlet channel in fluid connection with the bypass channel, and the switch controller is configured to receive an input from the second sensor, whereby upon detection of the bubble by the second sensor, the switch controller actuates the first fluidic switch to place the flow cell inlet channel in fluid connection with the flow cell inlet connection.

In some embodiments, the bypass channel is passively or actively in fluid communication with the flow cell outlet channel.

In some embodiments, the device of the system further includes a second fluidic switch that directs flow from the flow cell outlet connection or the bypass channel into the flow cell outlet channel. In some embodiments, the switch controller is further configured for controlling the second fluidic switch.

In some embodiments, the device of the system further includes a waste channel or reservoir in fluid communication with the bypass channel.

In some embodiments, the first and second sensors are optical sensors.

In some embodiments, the system further includes a flow cell having an inlet in fluid communication with the flow cell inlet connection and an outlet in fluid communication with the flow cell outlet connection.

In some embodiments, the system further includes a fluidic pump disposed to pump liquid in the flow cell.

In some embodiments, the system further includes a reagent reservoir in fluid communication with the first channel.

In some embodiments, the system further includes a pump controller for controlling the fluidic pump.

In some embodiments, the system further includes an imaging device or imaging system disposed to image a flow cell.

In some embodiments, the flow cell includes a sample. In some embodiments, an imaging device or imaging system is disposed to image the sample.

In one aspect, a method of controlling flow in a flow cell is provided. The method includes: (a) providing any of the devices described herein having a flow cell having an inlet in fluid communication with the flow cell inlet connection and an outlet in fluid communication with the flow cell outlet connection; (b) flowing a reagent liquid in the flow cell inlet channel, wherein the first fluidic switch directs flow into the flow cell via the flow cell inlet connection, wherein, upon detection of a bubble by the first sensor, the first fluidic switch directs flow into the bypass channel, wherein after detection of the bubble by the second sensor, the first fluidic switch directs flow to the flow cell.

In some embodiments, the method further includes: (c) detecting the bubble with the first sensor; and (d) actuating the first fluidic switch so that the flow cell inlet channel is in fluid communication with the bypass channel. In some embodiments, the method further includes: (e) detecting the bubble with the second sensor; and (f) actuating the first fluidic switch so that the flow cell inlet channel is in fluid communication with the flow cell.

In some embodiments, the method further includes: (c) detecting the bubble with the first sensor; and (d) actuating the first and second fluidic switches so that the flow cell inlet channel is in fluid communication with the bypass channel and the bypass channel is in fluid communication with the flow cell outlet channel. In some embodiments, the method further includes: (e) detecting the bubble with the second sensor; and (f) actuating the first and second fluidic switches so that the flow cell inlet channel is in fluid communication with the flow cell and the flow cell outlet channel.

In one aspect, a method of removing a bubble from a flow cell is provided. The method includes providing a flow cell having an inlet in fluid communication with the flow cell inlet connection and an outlet in fluid communication with the flow cell outlet connection, wherein the flow cell inlet intersects a first channel and a washing channel at a first intersection including a washing fluidic switch. The washing fluidic switch controls whether the flow cell inlet is in fluid communication with the first channel or the washing channel. The method further includes providing a first sensor disposed to detect a bubble in the flow cell; flowing a reagent liquid into the flow cell via the washing fluidic switch; upon the first sensor detecting a bubble, actuating the washing fluidic switch so that the flow cell inlet is in fluid communication with the washing channel; and flowing a washing liquid through the flow cell to remove the bubble. In some embodiments, the method further includes actuating the washing fluidic switch so that the flow cell inlet is in fluid communication with the first channel; and flowing the reagent liquid through the flow cell.

In some embodiments, the first sensor is an optical sensor.

In some embodiments, the washing fluidic switch and the first sensor are operatively linked to a washing switch controller, wherein the washing switch controller controls washing fluidic switch, and wherein the washing switch controller is configured to receive input from the first sensor.

In some embodiments, the first channel is in fluid communication with a reagent reservoir including the reagent liquid and the washing channel is in fluid communication with a washing reservoir including the washing liquid.

In some embodiments, the reagent liquid is aqueous.

In some embodiments, the washing liquid is more hydrophilic than the reagent liquid. In some embodiments, the washing liquid is more hydrophobic than the reagent liquid.

In some embodiments, the washing liquid includes an alcohol. In some embodiments, the washing liquid includes between 30% and 100% (e.g., between 30% and 90%, between 30% and 80%, between 30% and 70%, between 30% and 60%, between 30% and 50%, between 30% and 40%, between 40% and 100%, between 50% and 100%, between 60% and 100%, between 70% and 100%, between 80% and 100%, between 90% and 100%, between 40% and 60%, between 60% and 80%, between 50% and 70%, between 40% and 80%, between 70% and 90%, between 50% and 60%, between 60% and 70%, between 70% and 80%, or between 80% and 90%; e.g., about 30%, about 35%, about 40%, about 45%, about 50%, about 55%, about 60%, about 65%, about 70%, about 75%, about 80%, about 85%, about 90%, about 95%, or about 100%) alcohol (e.g., C1-3 alcohol; e.g., methanol, ethanol, or isopropanol).

In some embodiments, the alcohol is isopropanol, ethanol, or methanol. In some embodiments, the washing liquid includes between 30% and 100% (e.g., between 30% and 90%, between 30% and 80%, between 30% and 70%, between 30% and 60%, between 30% and 50%, between 30% and 40%, between 40% and 100%, between 50% and 100%, between 60% and 100%, between 70% and 100%, between 80% and 100%, between 90% and 100%, between 40% and 60%, between 60% and 80%, between 50% and 70%, between 40% and 80%, between 70% and 90%, between 50% and 60%, between 60% and 70%, between 70% and 80%, or between 80% and 90%; e.g., about 30%, about 35%, about 40%, about 45%, about 50%, about 55%, about 60%, about 65%, about 70%, about 75%, about 80%, about 85%, about 90%, about 95%, or about 100%) isopropanol, ethanol, and/or methanol.

In some embodiments, the washing liquid includes a surfactant or detergent (e.g., a nonionic surfactant or detergent or an ionic surfactant or detergent). In some embodiments, the washing liquid includes between 0.01% to 10% (e.g., between 0.01% to 10%, between 0.01% to 9%, between 0.01% to 8%, between 0.01% to 7%, between 0.01% to 6%, between 0.01% to 5%, between 0.01% to 4%, between 0.01% to 3%, between 0.01% to 2%, between 0.01% to 1%, between 0.01% to 0.9%, between 0.01% to 0.8%, between 0.01% to 0.7%, between 0.01% to 0.6%, between 0.01% to 0.5%, between 0.01% to 0.4%, between 0.01% to 0.3%, between 0.01% to 0.2%, between 0.01% to 0.1%, between 0.01% to 0.09%, between 0.01% to 0.08%, between 0.01% to 0.07%, between 0.01% to 0.06%, between 0.01% to 0.05%, between 0.01% to 0.04%, between 0.01% to 0.03%, between 0.01% to 0.02%, between 0.5% to 1%, between 0.5% to 5%, between 1% to 2%, between 1% to 5%, between 1% to 10%, between 5% to 10%, between 0.1% to 0.5%, between 0.1% to 1%, between 0.1% to 10%, between 2% to 4%, between 4% to 6%, between 6% to 8%, between 8% to 10%, between 0.05% to 0.1%, between 0.05% to 0.5%, between 0.05% to 1%, between 0.25% to 0.75%, between 0.5% to 2%, or between 0.05% to 0.1%; e.g., about 0.01%, about 0.02%, about 0.03%, about 0.04%, about 0.05%, about 0.75%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, or about 10%) w/v surfactant. In some embodiments, the surfactant or detergent is TRITON® X-100 (2-[4-(2,4,4-trimethylpentan-2-yl)phenoxy]ethanol; CAS #: 9002-93-1), TWEEN® 20 (polyoxyethylene (20) sorbitan monolaurate; CAS #: 9005-64-5), TWEEN® 80 (polyoxyethylene (20) sorbitan monooleate; CAS #: 9005-65-6), or sodium dodecyl sulfate (SDS).

### BRIEF DESCRIPTION OF THE DRAWINGS

FIG. 1A shows an exemplary device operatively coupled with a closed flow cell, according to embodiments of the disclosure.

FIG. 1B shows an exemplary device operatively coupled with a closed flow cell, according to embodiments of the disclosure.

FIGS. 2A-2D illustrate steps for preventing the introduction of a bubble into a closed flow cell using a device provided herein (e.g., the device exemplified in FIG. 1A), according to embodiments of the disclosure.

FIGS. 3A-3C illustrate steps for removing a bubble detected in a flow cell by using a washing liquid to wash the bubble out of the flow cell, according to embodiments of the disclosure.

### DETAILED DESCRIPTION

In general, devices, methods, and systems are provided for reducing (e.g., reducing by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells and removing existing bubbles from flow cells, e.g., by fluidically directing bubbles away from the flow cell or flushing flow cells having one or more bubbles with a washing liquid. In some instances, the devices, methods, and systems may be configured to minimize waste of reagents, e.g., while reducing (e.g., reducing by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells and removing existing bubbles from flow cells

### Definitions

The following definitions are provided for specific terms:

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

The terms “adaptor(s),” “adapter(s),” and “tag(s)” may be used synonymously. An adaptor or tag can be coupled to a polynucleotide sequence to be “tagged” by any approach including ligation, hybridization, or other approaches.

The term “barcode,” as used herein, generally refers to a label, or identifier, that conveys or is capable of conveying information about an analyte. A barcode can be part of an analyte. A barcode can be a tag attached to an analyte (e.g., nucleic acid molecule) or a combination of the tag in addition to an endogenous characteristic of the analyte (e.g., size of the analyte or end sequence(s)). A barcode may be unique. Barcodes can have a variety of different formats. For example, barcodes can include: polynucleotide barcodes; random nucleic acid and/or amino acid sequences; and synthetic nucleic acid and/or amino acid sequences. A barcode can be attached to an analyte in a reversible or irreversible manner. A barcode can be added to, for example, a fragment of a deoxyribonucleic acid (DNA) or ribonucleic acid (RNA) sample before, during, and/or after sequencing of the sample. Barcodes can allow for identification and/or quantification of individual sequencing-reads in real time.

The term “flow path,” as used herein, refers to a path of channels and other structures for liquid flow from at least one inlet to at least one outlet. A flow path may include branches and may connect to adjacent flow paths, e.g., by a common inlet or a connecting channel.

The term “fluidically connected,” as used herein, refers to a direct connection between at least two device elements, e.g., a channel, reservoir, etc., that allows for fluid to move between such device elements without passing through an intervening element.

The term “fluidically disposed between,” as used herein, refers to the location of one element between two other elements so that fluid can flow through the three elements in one direction of flow.

The term “genome,” as used herein, generally refers to genomic information from a subject, which may be, for example, at least a portion or an entirety of a subject's hereditary information. A genome can be encoded either in DNA or in RNA. A genome can include coding regions that code for proteins as well as non-coding regions. A genome can include the sequence of all chromosomes together in an organism. For example, the human genome has a total of 46 chromosomes. The sequence of all of these together may constitute a human genome.

The term “in fluid communication with”, as used herein, refers to a connection between at least two device elements, e.g., a channel, reservoir, etc., that allows for fluid to move between such device elements with or without passing through one or more intervening device elements. When two compartments in fluid communication are directly connected, i.e., connected in a manner allowing fluid exchange without necessity for the fluid to pass through any other intervening compartment, the two compartments are deemed to be fluidically connected.

The term “macromolecular constituent,” as used herein, generally refers to a macromolecule contained within or from a biological particle. The macromolecular constituent may include a nucleic acid. In some cases, the biological particle may be a macromolecule. The macromolecular constituent may include DNA or a DNA molecule. The macromolecular constituent may include RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may include a protein. The macromolecular constituent may include a peptide. The macromolecular constituent may include a polypeptide or a protein. The polypeptide or protein may be an extracellular or an intracellular polypeptide or protein. The macromolecular constituent may also include a metabolite. These and other suitable macromolecular constituents (also referred to as analytes) will be appreciated by those skilled in the art (see U.S. Pat. Nos. 10,011,872 and 10,323,278, and PCT Publication No. WO 2019/157529, each of which is incorporated herein by reference in its entirety).

The term “molecular tag,” as used herein, generally refers to a molecule capable of binding to a macromolecular constituent. The molecular tag may bind to the macromolecular constituent with high affinity. The molecular tag may bind to the macromolecular constituent with high specificity. The molecular tag may include a nucleotide sequence. The molecular tag may include an oligonucleotide or polypeptide sequence. The molecular tag may include a DNA aptamer. The molecular tag may be or include a primer. The molecular tag may be or include a protein. The molecular tag may include a polypeptide. The molecular tag may be a barcode.

The term “oil,” as used herein, generally refers to a liquid that is not miscible with water. An oil may have a density higher or lower than water and/or a viscosity higher or lower than water.

The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. Tissue samples may originate from organs, including, but not limited to, eye, brain, lymph node, lung, heart, liver, kidney, stomach, intestine, colon, bladder. The sample may be fresh, frozen, fixed (e.g., with an aldehyde (e.g., formalin, paraformaldehyde, gluteraldehyde) or with an alcohol (e.g., methanol or ethanol), and/or paraffin-embedded. The sample may be a skin sample. The sample may be a cheek swab. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

### Devices

The devices described herein can be used to reduce (e.g., reduce by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells or to remove existing bubbles from flow cells. An exemplary device includes (i) a flow cell inlet connection, (ii) a flow cell outlet connection, (iii) a flow cell inlet channel, (iv) a flow cell outlet channel, (v) a first sensor, (vi) a second sensor, (vii) a first fluidic switch, and (viii) a bypass channel, wherein the first fluidic switch directs flow from the flow cell inlet channel into either the flow cell inlet connection or the bypass channel, the flow cell outlet connection is in fluid communication with the flow cell outlet channel, the first sensor is disposed to detect a bubble upstream of the first fluidic switch, and the second sensor is disposed to detect the bubble in the bypass channel. In some instances, the bypass channel is passively or actively in fluid communication with the flow cell outlet channel. In some instances, devices described herein further include a second fluidic switch that directs flow from the flow cell outlet connection or the bypass channel into the flow cell outlet channel. In some instances, devices described herein further include a waste channel or reservoir in fluid communication with the bypass channel.

Another exemplary device includes (i) a flow cell inlet connection, (ii) a flow cell outlet connection, (iii) a flow cell inlet channel, (iv) a flow cell outlet channel, (v) a first sensor, (vi) a washing fluidic switch, and (vii) a washing channel. The washing fluidic switch directs flow from either the flow cell inlet channel or the washing channel into the flow cell inlet connection; the flow cell outlet connection is in fluid communication with the flow cell outlet channel; and the first sensor is disposed to detect a bubble downstream of the washing fluidic switch, e.g., in the flow cell.

In some instances, the first and/or second sensors are optical sensors.

In some instances, devices described herein further include a flow cell having an inlet in fluid communication with the flow cell inlet connection and an outlet in fluid communication with the flow cell outlet connection. In some instances, the flow cell is an enclosed flow cell, e.g., a closed flow cell. In some instances, the flow cell is sealed. In some instances, the flow cell is an open flow cell. In some instance, liquids in the flow cell are in contact with air.

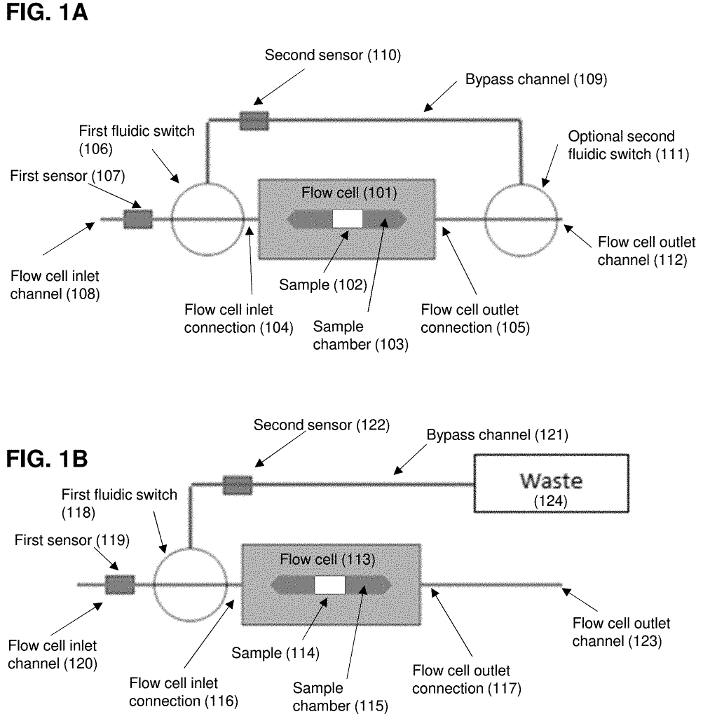

An exemplary device having a second fluidic switch and having a flow cell having an inlet in fluid communication with the flow cell inlet connection and an outlet in fluid communication with the flow cell outlet connection is shown in FIG. 1A. An exemplary device having a waste channel or reservoir and having a flow cell having an inlet in fluid communication with the flow cell inlet connection and an outlet in fluid communication with the flow cell outlet connection is shown in FIG. 1B.

Suitable fluidic switches are known in the art. Fluidic switches can be controlled manually, electrically, magnetically, hydraulically, pneumatically, or by a combination thereof.

In some instances, the flow cell includes an optically transparent window. In some instances, the optically transparent window is glass or plastic.

In some instances, a fluidic switch is capable of actuating once every millisecond to once every minute (e.g., once every 1 ms to 10 ms, 10 ms to 50 ms, 50 ms to 500 ms, 200 ms to 1 s, 5 ms to 50 ms, 50 ms to 100 ms, 10 ms to 100 ms, 100 ms to 500 ms, 100 ms to 1 s, 500 ms to 1 s, 1 s to 10 s, 1 s to 30 ms, 1 s to 60 s, 30 s to 60 s, 5 s to 10 s, 10 s to 30 s, 500 ms to 5 s, 1 ms to 1 s; e.g., once every about 1 ms, 5 ms, 10 ms, 20 ms, 30 ms, 40 ms, 50 ms, 100 ms, 200 ms, 300 ms, 400 ms, 500 ms, 1 s, 2 s, 3 s, 4 s, 5 s, 6 s, 7 s, 8 s, 9 s, 10 s, 15 s, 20 s, 25 s, 30 s, 35 s, 40 s, 45 s, 50 s, 55 s, or 60 s).

Channels have a depth and a width. The depth and width of the channels of a device may be the same, or one may be larger than the other, e.g., the width is larger than the depth, or first depth is larger than the width. In some instances, the depth and/or width is between about 0.1 μm and 2000 μm. In some embodiments, the depth and/or width of a channel is from 500 to 1000 μm, 1000 to 2000 μm, 1 to 750 μm, 1 to 500 μm, 1 to 250 μm, 1 to 100 μm, 1 to 50 μm, or 3 to 40 μm. In some cases, when the width and length differ, the ratio of the width to depth is, e.g., from 0.1 to 10, e.g., 0.5 to 2 or greater than 3, such as 3 to 10, 3 to 7, or 3 to 5. The width and depths of a channel may or may not be constant over its length. In particular, the width may increase or decrease adjacent the distal end. In general, channels may be of any suitable cross section, such as a rectangular, triangular, or circular, or a combination thereof. In some instances, the flow cell inlet connection and flow cell outlet connection are channels.

In some instances, the device may include a receptable or housing. In some instances, the receptacle or housing has a shape and a size suitable for holding a flow cell. In some instances, the receptacle or housing holds a flow cell having an inlet in fluid communication with the flow cell inlet connection and an outlet in fluid communication with the flow cell outlet connection. In some instances, the receptacle or housing may have a size and/or shape suitable for holding a flow cell described herein. In some instances, the device or a portion of a device (e.g., the receptacle or housing) may be configured to apply a force to hold a flow cell substantially in place.

### Systems

The systems described herein can be used to reduce (e.g., reduce by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells or to remove existing bubbles from flow cells.

The systems can include any device described herein. In some instances, the system includes a fluidic pump disposed to pump liquid in a flow cell having an inlet in fluid communication with the flow cell inlet connection and an outlet in fluid communication with the flow cell outlet connection. In some instances, the system includes a flow cell. In some instances, systems described herein further include a reagent reservoir in fluid communication with the first channel.

In some instances, systems described herein further include a switch controller for controlling the first and/or second fluidic switches. In some instances, the switch controller is configured to receive input from the first and second sensors.

In some instances, systems described herein further include a pump controller for controlling the fluidic pump.

In some instances, systems described herein further include an imaging device or imaging system disposed to image a flow cell having an inlet in fluid communication with the flow cell inlet connection and an outlet in fluid communication with the flow cell outlet connection.

In some instances, the flow cell of systems described herein includes a sample. In some instances, an imaging device or imaging system is disposed to image the sample.

An exemplary system includes (a) a device including: (i) a flow cell inlet connection, (ii) a flow cell outlet connection, (iii) a flow cell inlet channel, (iv) a flow cell outlet channel, (v) a first sensor, (vi) a second sensor, (vii) a first fluidic switch, and (viii) a bypass channel, wherein the first fluidic switch directs flow from the flow cell inlet channel into either the flow cell inlet connection or the bypass channel, the flow cell outlet connection is in fluid communication with the flow cell outlet channel, the first sensor is disposed to detect a bubble upstream of the first fluidic switch, and the second sensor is disposed to detect the bubble in the bypass channel; and (b) a switch controller for controlling the first switch. The switch controller is configured to receive an input from the first sensor, whereby upon detection of a bubble by the first sensor, the switch controller actuates the first fluidic switch to place the flow cell inlet channel in fluid connection with the bypass channel, and the switch controller is configured to receive an input from the second sensor, whereby upon detection of the bubble by the second sensor, the switch controller actuates the first fluidic switch to place the flow cell inlet channel in fluid connection with the flow cell inlet connection.

In some instances, the bypass channel is passively or actively in fluid communication with the flow cell outlet channel.

In some instances, the device of the system further includes a second fluidic switch that directs flow from the flow cell outlet connection or the bypass channel into the flow cell outlet channel. In some instances, the switch controller is further configured for controlling the second fluidic switch.

In some instances, the device of the system further includes a waste channel or reservoir in fluid communication with the bypass channel.

In some instances, the first and second sensors are optical sensors.

In some instances, the system further includes a flow cell having an inlet in fluid communication with the flow cell inlet connection and an outlet in fluid communication with the flow cell outlet connection.

In some instances, the system further includes a fluidic pump disposed to pump liquid in the flow cell.

In some instances, the system further includes a reagent reservoir in fluid communication with the first channel.

In some instances, the system further includes a pump controller for controlling the fluidic pump.

In some instances, the system further includes an imaging device or imaging system disposed to image a flow cell having an inlet in fluid communication with the flow cell inlet connection and an outlet in fluid communication with the flow cell outlet connection.

In some instances, the flow cell includes a sample. In some instances, an imaging device or imaging system is disposed to image the sample.

In some instances, the systems described herein include one or more fluidic pumps to direct the flow of one or more liquids, such as a reagent liquid and/or a washing liquid. In some instances, the fluidic pump includes a compressor to provide positive pressure at an upstream location to direct the liquid from the upstream location to flow to a downstream location. In some instances, the fluidic pump includes a pump to provide negative pressure at a downstream location to direct the liquid from an upstream location to flow to the downstream location. In some instances, the fluidic pump includes both a compressor and a pump, each at different locations. In some instances, the fluidic pump includes different systems at different locations. In some instances, the system includes one or more integrated fluidic pumps or is connectable to one or more fluidic pumps. Examples of pressure pumps include syringe, peristaltic, diaphragm pumps, and sources of vacuum. Other pumps can employ centrifugal or electrokinetic forces. Alternatively, liquid movement may be controlled by gravity, capillarity, or surface treatments. Multiple pumps and mechanisms for liquid movement may be employed in a single system. In some instances, the system includes one or more vents to allow pressure equalization, and one or more filters to remove particulates or other undesirable components from a liquid.

Fluidic switches and sensors of the systems described herein may be operatively coupled to one or more controllers or computers, e.g., by being integrated with, physically connected to (mechanically or electrically), or by wired or wireless connection. The controllers or computers may actuate the fluidic switches of the system based on input received from the sensors (e.g., first and/or second sensors) and further based on an algorithm.

In some instances, sensors detect a bubble by detecting the air-liquid interface between the liquid and the bubble. In some instances, sensors described herein detect a bubble by detecting the presence of air in a channel of the devices described herein. In some instances, a detected bubble includes the leading edge of the bubble. In some instances, a detected bubble includes both the leading and trailing edges of the bubble. In some instances, the controllers, processors, or computers of the system keep track of the number of bubbles detected by the first and second sensors. In some instances, the switch controllers control the fluidic switch(es) such that the number of bubbles detected by the first sensor and the number of bubbles detected by the second sensor are the same (e.g., ±0, 1, or 2 bubbles) before placing the flow cell inlet channel and/or the flow cell outlet channel in fluid communication with the flow cell.

### Methods

The methods described herein can be used to reduce (e.g., reduce by about 5%, 10%, 15%, 20%, 25%, 30%, 35%, 40%, 45%, 50%, 55%, 60%, 65%, 70%, 75%, 80%, 85%, 90%, 95%, or 100%) the introduction of bubbles to flow cells or to remove existing bubbles from flow cells (e.g., using any of the devices and/or systems described herein). The method may include providing a device described herein; and flowing a reagent liquid in the flow cell inlet channel. The first fluidic switch directs flow into the flow cell via the flow cell inlet connection, and, upon detection of a bubble by the first sensor, the first fluidic switch directs flow into the bypass channel. After detection of the bubble by the second sensor, the first fluidic switch directs flow to the flow cell.

In some instances, the method may further include detecting the bubble with the first sensor and actuating the first fluidic switch so that the flow cell inlet channel is in fluid communication with the bypass channel. In some instances, the method further includes detecting the bubble with the second sensor and actuating the first fluidic switch so that the flow cell inlet channel is in fluid communication with the flow cell.

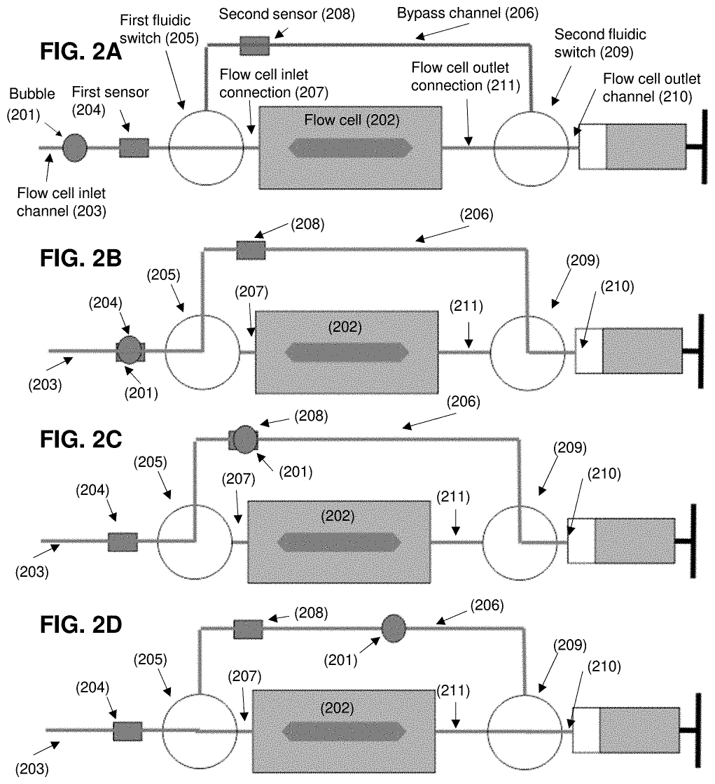

In some instances, the method may further include detecting the bubble with the first sensor; and actuating the first and second fluidic switches so that the flow cell inlet channel is in fluid communication with the bypass channel and the bypass channel is in fluid communication with the flow cell outlet channel. In some instances, the method further includes detecting the bubble with the second sensor and actuating the first and second fluidic switches so that the flow cell inlet channel is in fluid communication with the flow cell and the flow cell outlet channel. A schematic exemplifying this process is shown in FIGS. 2A-2D.

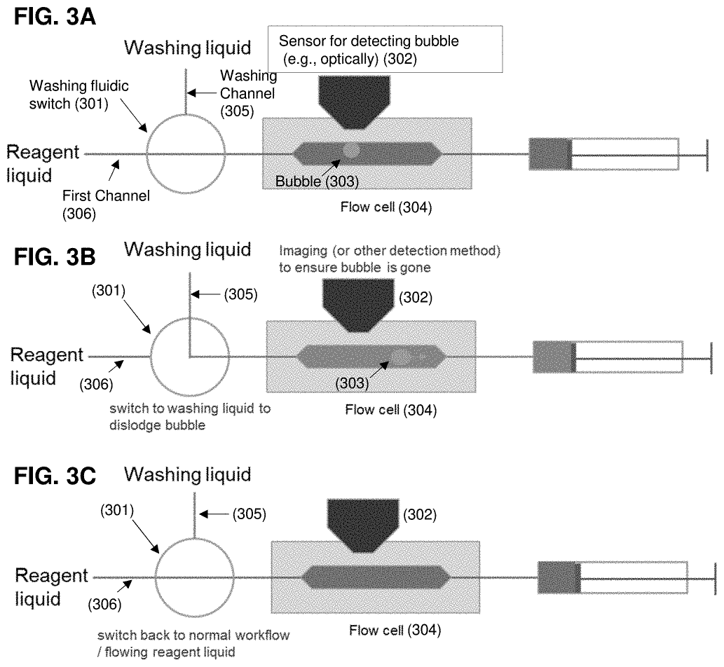

In various embodiments, a method of removing a bubble from a flow cell is provided. The method may include providing a flow cell having an inlet in fluid communication with the flow cell inlet connection and an outlet in fluid communication with the flow cell outlet connection. The flow cell inlet intersects a first channel and a washing channel at a first intersection including a washing fluidic switch, and the washing fluidic switch controls whether the flow cell inlet is in fluid communication with the first channel or the washing channel. The method may further include providing a first sensor disposed to detect a bubble in the flow cell; flowing a reagent liquid into the flow cell via the washing fluidic switch; actuating the washing fluidic switch upon the first sensor detecting a bubble, so that the flow cell inlet is in fluid communication with the washing channel; and flowing a washing liquid through the flow cell to remove the bubble. In some instances, the method further includes actuating the washing fluidic switch so that the flow cell inlet is in fluid communication with the first channel and flowing the reagent liquid through the flow cell. A schematic exemplifying this process is shown in FIGS. 3A-3C.

In some instances, the washing fluidic switch and the first sensor are operatively linked to a washing switch controller, wherein the washing switch controller controls washing fluidic switch, and wherein the washing switch controller is configured to receive input from the first sensor.

In some instances, the first channel is in fluid communication with a reagent reservoir including the reagent liquid and the washing channel is in fluid communication with a washing reservoir including the washing liquid.

In some instances, the reagent and/or washing liquids are miscible with water. In some instances, the reagent and washing liquids are aqueous. A discussion of exemplary liquids suitable for use with the flow cells described herein is provided below.

In some instances, the switching (e.g., to control fluid communication to the flow cell or to the bypass channel) and/or the washing fluidic switch (e.g., to deliver washing liquid to the flow cell) is configured to be performed in an automated fashion. For example, the device is automated to control the fluid flows and switching based on the detection of a bubble (e.g., via the imaging devices and methods described herein).

### Flow Cells

Flow cells can be used in the systems and methods described herein. In some instances, a flow cell may include a sample. A flow cell may include an inlet and an outlet to allow fluid to flow through into and out of the flow path of the device. In some instances, the inlet is in fluid communication with the flow cell inlet connection of the devices described herein. In some instances, the outlet is in fluid communication with the flow cell outlet connection of the devices described herein. In some instances, a flow cell may be placed into a receptacle or housing of a device described herein.

Flow cells may include a first layer and a second layer. In some instances, the first layer includes the inlet and/or the outlet. In some instances, the second layer includes the inlet and/or the outlet. In some instances, the first layer includes the inlet, and the second layer includes the outlet. In some instances, the second layer includes the inlet, and the first layer includes the outlet.

The first layer and/or second layer may be any suitable shape, such as a square, rectangle, or circle. In some instances, the length and/or width of the first layer and/or second layer is, independently, from about 1 mm to about 10 cm, e.g., from about 1 mm to about 1 cm, e.g., about 2 mm, 3 mm, 4 mm, 5 mm, 6 mm, 7 mm, 8 mm, 9 mm, or 1 cm, e.g., from about 1 cm to about 10 cm, e.g., about 2 cm, 3 cm, 4 cm, 5 cm, 6 cm, 7 cm, 8 cm, 9 cm, or 10 cm. In some instances, the first layer and/or second layer is a coverslip, e.g., having dimensions of about 22 mm by 22 mm (square), about 24 mm by about 50 mm (rectangle), or a circle with diameter of about 12 mm or about 25 mm.

In some instances, a flow cell may include a window. The window may be any suitable shape, such as a square, rectangle, or circle, to visualize or image a sample disposed inside a flow cell.

The window may have a thickness of about 1 μm to about 1000 μm. In some embodiments, the thickness of each window is from about 1 μm to about 500 μm, from about 1 μm to about 250 μm, from about 10 μm to about 100 μm, from about 100 μm to about 500 μm, from about 100 μm to about 300 μm, from about 100 μm to about 200 μm, from about 120 μm to about 190 μm, or from about 150 μm to about 180 μm. In some embodiments, the thickness of each window is from about 1 μm to about 10 μm, e.g., about 1 μm, 2 μm, 3 μm, 4 μm, 5 μm, 6 μm, 7 μm, 8 μm, 9 μm, or 10 μm, e.g., from about 10 μm to about 100 μm, e.g., about 10 μm, 20 μm, 30 μm, 40 μm, 50 μm, 60 μm, 70 μm, 80 μm, 90 μm, or 100 μm, e.g., from about 100 μm to about 1 mm, e.g., about 100 μm, 200 μm, 300 μm, 400 μm, 500 μm, 600 μm, 700 μm, 800 μm, 900 μm, or 1 mm. In some embodiments, the thickness of each window is about 0.17 mm. In some instances, the length and/or width of the window is, independently, from about 1 mm to about 10 cm, e.g., from about 1 mm to about 1 cm, e.g., about 2 mm, 3 mm, 4 mm, 5 mm, 6 mm, 7 mm, 8 mm, 9 mm, or 1 cm, e.g., from about 1 cm to about 10 cm, e.g., about 2 cm, 3 cm, 4 cm, 5 cm, 6 cm, 7 cm, 8 cm, 9 cm, or 10 cm. In some instances, the window is a coverslip, e.g., having dimensions of about 22 mm by 22 mm (square), about 24 mm by about 50 mm (rectangle), or a circle with diameter of about 12 mm or about 25 mm.

In some instances, the thickness of the window is from about 1 μm to about 1 mm. In some instances, the thickness of the window is from about 1 μm to about 500 μm, from about 1 μm to about 250 μm, from about 10 μm to about 100 μm, from about 100 μm to about 500 μm, from about 100 μm to about 300 μm, from about 100 μm to about 200 μm, from about 120 μm to about 190 μm, or from about 150 μm to about 180 μm. In some instances, the thickness of the window is from about 1 μm to about 10 μm, e.g., about 1 μm, 2 μm, 3 μm, 4 μm, 5 μm, 6 μm, 7 μm, 8 μm, 9 μm, or 10 μm, e.g., from about 10 μm to about 100 μm, e.g., about 10 μm, 20 μm, 30 μm, 40 μm, 50 μm, 60 μm, 70 μm, 80 μm, 90 μm, or 100 μm, e.g., from about 100 μm to about 1 mm, e.g., about 100 μm, 200 μm, 300 μm, 400 μm, 500 μm, 600 μm, 700 μm, 800 μm, 900 μm, or 1 mm. In some instances, the thickness of the window is about 0.17 mm.

The first layer of a flow cell may include a window having a thickness of about 1 μm to about 1000 μm, and the first and second layers reversibly seal to form a flow path having an inlet and an outlet and bounded in part by the window. The thickness of the first layer bounding the window may be greater than the thickness of the window. Alternatively, the thickness of the first layer bounding the window may be substantially the same thickness as the window. In some instances, the thickness of the first layer bounding the window is from about 1 μm to about 1 mm. In some instances, the thickness of the first layer bounding the window is from about 1 μm to about 500 μm, from about 1 μm to about 250 μm, from about 10 μm to about 100 μm, from about 100 μm to about 500 μm, from about 100 μm to about 300 μm, from about 100 μm to about 200 μm, from about 120 μm to about 190 μm, or from about 150 μm to about 180 μm. In some instances, the thickness of the first layer bounding the window is from about 1 μm to about 10 μm, e.g., about 1 μm, 2 μm, 3 μm, 4 μm, 5 μm, 6 μm, 7 μm, 8 μm, 9 μm, or 10 μm, e.g., from about 10 μm to about 100 μm, e.g., about 10 μm, 20 μm, 30 μm, 40 μm, 50 μm, 60 μm, 70 μm, 80 μm, 90 μm, or 100 μm, e.g., from about 100 μm to about 1 mm, e.g., about 100 μm, 200 μm, 300 μm, 400 μm, 500 μm, 600 μm, 700 μm, 800 μm, 900 μm, or 1 mm.

In some instances, the first layer and the second layer are configured to form a fluid tight seal. For example, the layers may be sealed via an adhesive, conformal contact, or by capillary force. In some instances, a force is applied to the flow cell (e.g., to the first and second layers of the flow cell) to maintain the seal. The flow cell may be configured for use with a clamp to apply a force and maintain the seal. In some instances, the force for maintaining the seal may be applied by a device or a portion of a device (e.g., a receptacle or housing of a device) holding the flow cell. In some instances, the first and/or second layer includes an elastomer, e.g., polydimethylsiloxane (PDMS). The elastomer may assist in allowing the layers to conformally contact each other to maintain the seal.

The flow cell described herein may include a flow path having an inlet and an outlet and bounded in part by the window. The flow path may be any suitable geometry, such as a cylindrical flow path, square flow path, rectangular flow path, or the like.

In some instances, the width and/or height of the flow path is, independently, from about 1 μm to about 1 cm. In some instances, width and/or height of the flow path is, independently, from about 1 μm to about 500 μm, from about 1 μm to about 250 μm, from about 10 μm to about 100 μm, from about 100 μm to about 500 μm, from about 100 μm to about 300 μm, from about 100 μm to about 200 μm, from about 120 μm to about 190 μm, or from about 150 μm to about 180 μm, In some instances, the width and/or height of the flow path is, independently, from about 1 μm to about 10 μm, e.g., about 1 μm, 2 μm, 3 μm, 4 μm, 5 μm, 6 μm, 7 μm, 8 μm, 9 μm, or 10 μm, e.g., from about 10 μm to about 100 μm, e.g., about 10 μm, 20 μm, 30 μm, 40 μm, 50 μm, 60 μm, 70 μm, 80 μm, 90 μm, or 100 μm, e.g., from about 100 μm to about 1 mm, e.g., about 100 μm, 200 μm, 300 μm, 400 μm, 500 μm, 600 μm, 700 μm, 800 μm, 900 μm, or 1 mm, e.g., from about 1 mm to about 1 cm, e.g., about 2 mm, 3 mm, 4 mm, 5 mm, 6 mm, 7 mm, 8 mm, 9 mm, or 1 cm.

In some instances, the length of the flow path is longer than the width and/or height of the flow path. In some instances, the length of the flow path is, e.g., from about 100 μm to about 10 cm, e.g., from about 100 μm to about 1 mm, e.g., about 100 μm, 200 μm, 300 μm, 400 μm, 500 μm, 600 μm, 700 μm, 800 μm, 900 μm, or 1 mm, e.g., from about 1 mm to about 1 cm, e.g., about 1 mm, 2 mm, 3 mm, 4 mm, 5 mm, 6 mm, 7 mm, 8 mm, 9 mm, or 1 cm, e.g., from about 1 cm to about 10 cm, e.g., 2 cm, 3 cm, 4 cm, 5 cm, 6 cm, 7 cm, 8 cm, 9 cm, or 10 cm.

The flow cell or the layers of a flow cell as described herein may be composed of polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like. The layers may be fabricated in whole or in part from inorganic materials, such as silicon, or other silica-based materials, e.g., glass, quartz, fused silica, borosilicate glass, metals, ceramics, and combinations thereof. Polymeric flow cell components may be fabricated using any of a number of processes including soft lithography, embossing techniques, micromachining, e.g., laser machining.

### Liquids

Liquids employed in the devices, systems, and methods may be miscible with water. Liquids miscible with water may be aqueous. Examples of aqueous liquid media include, e.g., sterile water, phosphate buffered saline, Tris buffer, and other aqueous solutions (e.g., other buffer solutions) known in the art.

In some instances, liquids include reagents. In some instances, a liquid (e.g., a reagent liquid) is stored in a reservoir (e.g., a reagent reservoir). In some instances, the reagent reservoir is in fluid communication with the flow cell inlet channel.

In some instances, a liquid may be a washing liquid. In some instances, washing liquids are aqueous or non-aqueous. In some embodiments, the washing liquid is more hydrophilic than the reagent liquid. In some embodiments, the washing liquid is more hydrophobic than the reagent liquid.

In some embodiments, the washing liquid includes a solvent (e.g., organic solvent) that is miscible with water. In some embodiments, the washing liquid includes between 30% and 100% (e.g., between 30% and 90%, between 30% and 80%, between 30% and 70%, between 30% and 60%, between 30% and 50%, between 30% and 40%, between 40% and 100%, between 50% and 100%, between 60% and 100%, between 70% and 100%, between 80% and 100%, between 90% and 100%, between 40% and 60%, between 60% and 80%, between 50% and 70%, between 40% and 80%, between 70% and 90%, between 50% and 60%, between 60% and 70%, between 70% and 80%, or between 80% and 90%; e.g., about 30%, about 35%, about 40%, about 45%, about 50%, about 55%, about 60%, about 65%, about 70%, about 75%, about 80%, about 85%, about 90%, about 95%, or about 100%) solvent w/v or v/v.

In some embodiments, the washing liquid includes an alcohol, e.g., isopropanol, ethanol, methanol, or a combination thereof. In some embodiments, the washing liquid includes between 30% and 100% (e.g., between 30% and 90%, between 30% and 80%, between 30% and 70%, between 30% and 60%, between 30% and 50%, between 30% and 40%, between 40% and 100%, between 50% and 100%, between 60% and 100%, between 70% and 100%, between 80% and 100%, between 90% and 100%, between 40% and 60%, between 60% and 80%, between 50% and 70%, between 40% and 80%, between 70% and 90%, between 50% and 60%, between 60% and 70%, between 70% and 80%, or between 80% and 90%; e.g., about 30%, about 35%, about 40%, about 45%, about 50%, about 55%, about 60%, about 65%, about 70%, about 75%, about 80%, about 85%, about 90%, about 95%, or about 100%) alcohol (e.g., isopropanol, ethanol, or methanol) v/v.

In some embodiments, the washing liquid includes a surfactant or detergent (e.g., a nonionic surfactant or detergent or an ionic surfactant or detergent). In some embodiments, the washing liquid includes between 0.01% to 10% (e.g., between 0.01% to 10%, between 0.01% to 9%, between 0.01% to 8%, between 0.01% to 7%, between 0.01% to 6%, between 0.01% to 5%, between 0.01% to 4%, between 0.01% to 3%, between 0.01% to 2%, between 0.01% to 1%, between 0.01% to 0.9%, between 0.01% to 0.8%, between 0.01% to 0.7%, between 0.01% to 0.6%, between 0.01% to 0.5%, between 0.01% to 0.4%, between 0.01% to 0.3%, between 0.01% to 0.2%, between 0.01% to 0.1%, between 0.01% to 0.09%, between 0.01% to 0.08%, between 0.01% to 0.07%, between 0.01% to 0.06%, between 0.01% to 0.05%, between 0.01% to 0.04%, between 0.01% to 0.03%, between 0.01% to 0.02%, between 0.5% to 1%, between 0.5% to 5%, between 1% to 2%, between 1% to 5%, between 1% to 10%, between 5% to 10%, between 0.1% to 0.5%, between 0.1% to 1%, between 0.1% to 10%, between 2% to 4%, between 4% to 6%, between 6% to 8%, between 8% to 10%, between 0.05% to 0.1%, between 0.05% to 0.5%, between 0.05% to 1%, between 0.25% to 0.75%, between 0.5% to 2%, or between 0.05% to 0.1%; e.g., about 0.01%, about 0.02%, about 0.03%, about 0.04%, about 0.05%, about 0.75%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, or about 10%) w/v surfactant. In some embodiments, the surfactant or detergent is TRITON® X-100 (2-[4-(2,4,4-trimethylpentan-2-yl)phenoxy]ethanol; CAS #: 9002-93-1), TWEEN® 20 (polysorbate 20 or polyoxyethylene (20) sorbitan monolaurate; CAS #: 9005-64-5), TWEEN® 80 (polysorbate 80 or polyoxyethylene (20) sorbitan monooleate; CAS #: 9005-65-6), or sodium dodecyl sulfate (SDS).

### Surface Properties

The devices and flow cells employed in the systems and methods may have a surface modification, e.g., a surface with a coating, e.g., a hydrophobic coating, or a surface texture. A surface of the device or flow cell may include a material, coating, or surface texture that determines the physical properties of the device. In particular, the flow of liquids through a device or flow cell may be controlled by the surface properties (e.g., wettability of a liquid-contacting surface). In some cases, a device or flow cell may have a surface having a wettability suitable for facilitating liquid flow or for creating a hydrophobic boundary.

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method. The wettability of each surface may be suited to creating a hydrophobic boundary.

For example, portions of the device (e.g., channels and/or fluidic switches) or a flow cell carrying aqueous phases may have a surface material or coating that is hydrophilic or more hydrophilic than an adjacent region, e.g., include a material or coating having a water contact angle of less than or equal to about 90°. Devices and flow cells can be designed to have a single type of material or coating throughout. Alternatively, devices or flow cells may have separate regions having different materials or coatings.

The surface properties of devices or flow cells may be those of a native surface (i.e., the surface properties of the bulk material used for in the fabrication of the devices or flow cells) or of a surface treatment. Non-limiting examples of surface treatments include, e.g., surface coatings and surface textures. In one approach, the surface properties are attributable to one or more surface coatings present in a portion of a device or flow cell. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the flow cell or channel. Example metal oxides useful for coating surfaces include, but are not limited to, Al₂O₃, TiO₂, SiO₂, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be deposited on a surface by contacting it with trimethylaluminum (TMA) and water.

In other instances, the device surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a contact angle greater than 150°. Exemplary superhydrophobic materials include Manganese Oxide Polystyrene (MnO₂/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoro-ethylene) (CTFE), perfluoro-alkoxyalkane (PFA), and poly(vinylidene fluoride) (PVDF). Other superhydrophobic surfaces are known in the art.

In some instances, the contact angle between a liquid (e.g., a reagent liquid or washing liquid) with a flow cell surface (e.g., with the material or coating of the flow cell surface) is less than or equal to about 90° (e.g., less than 80°, 70°, 60°, 50°, 40°, 30°, 20°, or 10°; e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°). In some instances, the contact angle between a liquid (e.g., a reagent liquid or washing liquid) with a flow cell surface (e.g., with the material or coating of the flow cell surface) is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about 150°).

The difference in water contact angles between a flow cell surface (e.g., the material or coating of the flow cell surface) and a reagent liquid and between the flow cell surface (e.g., the material or coating of the flow cell surface) and a washing liquid may be 5° to 100° (e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°; e.g., 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, or 100°).

It will be understood the determination of a contact angle of a material or coating can be made on that material or coating when not incorporated into a device described herein.

### Reagents

In some instances, the reagent liquid includes a reagent for detecting a nucleic acid in the sample, e.g., via a nucleic acid sequencing reaction. In some instances, the reagent is for a DNA sequencing reaction or an RNA sequencing reaction. In some instances, the reagent liquid includes a reagent for an in situ assay, e.g., in situ hybridization, in situ sequencing techniques, in situ detection and analysis of target analytes. Non-limiting examples of assays include sequencing by synthesis (SBS), sequencing by ligation (SBL), sequencing by hybridization (SBH) and various in situ hybridization techniques. In some cases, the assays may include detecting, quantifying, and/or mapping analytes (e.g., gene activity) to specific regions or locations in a biological sample (e.g., a tissue sample or cells deposited on a surface) at cellular or sub-cellular resolution. In some instances, the reagent is for in situ hybridization (ISH). In some instances, the reagent is for fluorescence in situ hybridization (FISH).

In some instances, the reagent liquid includes a reagent for detecting a protein in the sample. In some instances, the reagent is for immunohistochemistry (IHC).

In some instances, the reagent liquid includes a reagent for an enzymatic reaction.

In some instances, the reagent liquid includes a reagent for a chemical reaction.

In some instances, reagents are selected from the list including antibodies, buffers, enzymes, chelators, nucleotides, oligonucleotides, probes, probe sets, dyes, chemical crosslinkers, permeabilization reagents, clearing reagents, quenchers, and salts. In some instances, reagents are used for an assay that may detect a molecule or a complex generated in a series of reactions, e.g., hybridization, ligation, extension, replication, transcription/reverse transcription, and/or amplification (e.g., rolling circle amplification), in any suitable combination.

Additional exemplary reagents and applicable reactions and assays are described below.

### Preparation of Samples

Reagents may be used to prepare a sample (e.g., a biological sample; e.g., a biological tissue sample) for analysis using a variety of techniques. Except where indicated otherwise, the preparative steps described below can generally be combined in any manner to appropriately prepare a particular sample for analysis.

A sample disclosed herein can be or derived from any biological sample. Methods and compositions disclosed herein may be used for analyzing a biological sample, which may be obtained from a subject using any of a variety of techniques including, but not limited to, biopsy, surgery, and laser capture microscopy (LCM), and generally includes cells and/or other biological material from the subject. In addition to the subjects described above, a biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample, a patient derived organoid (PDO) or patient derived xenograft (PDX). A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic individuals, individuals that have or are suspected of having a disease (e.g., a patient with a disease such as cancer) or a pre-disposition to a disease, and/or individuals in need of therapy or suspected of needing therapy.

The biological sample can include any number of macromolecules, for example, cellular macromolecules and organelles (e.g., mitochondria and nuclei). The biological sample can be a nucleic acid sample and/or protein sample. The biological sample can be a carbohydrate sample or a lipid sample. The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions. In some instances, the biological sample may comprise cells which are deposited on a surface.

Cell-free biological samples can include extracellular macromolecules, e.g., polynucleotides. Extracellular polynucleotides can be isolated from a bodily sample, e.g., blood, plasma, serum, urine, saliva, mucosal excretions, sputum, stool, and tears.

Biological samples can be derived from a homogeneous culture or population of the subjects or organisms mentioned herein or alternatively from a collection of several different organisms, for example, in a community or ecosystem.

Biological samples can include one or more diseased cells. A diseased cell can have altered metabolic properties, gene expression, protein expression, and/or morphologic features. Examples of diseases include inflammatory disorders, metabolic disorders, nervous system disorders, and cancer. Cancer cells can be derived from solid tumors, hematological malignancies, cell lines, or obtained as circulating tumor cells. Biological samples can also include fetal cells and immune cells.

In some instances, a substrate herein can be any support that is insoluble in aqueous liquid and which allows for positioning of biological samples, analytes, features, and/or reagents (e.g., probes) on the support. In some instances, a biological sample can be attached to a substrate. Attachment of the biological sample can be irreversible or reversible, depending upon the nature of the sample and subsequent steps in the analytical method. In certain instances, the sample can be attached to the substrate reversibly by applying a suitable polymer coating to the substrate, and contacting the sample to the polymer coating. The sample can then be detached from the substrate, e.g., using an organic solvent that at least partially dissolves the polymer coating. In some instances, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

### Tissue Sectioning:

A biological sample can be harvested from a subject (e.g., via surgical biopsy, whole subject sectioning) or grown in vitro on a growth substrate or culture dish as a population of cells, and prepared for analysis as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some instances, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., 10-20 μm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 μm. Thicker sections can also be used if desired or convenient, e.g., at least 70, 80, 90, or 100 μm or more. Typically, the thickness of a tissue section is between 1-100 μm, 1-50 μm, 1-30 μm, 1-25 μm, 1-20 μm, 1-15 μm, 1-10 μm, 2-8 μm, 3-7 μm, or 4-6 μm, but as mentioned above, sections with thicknesses larger or smaller than these ranges can also be analysed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analysed successively to obtain three-dimensional information about the biological sample.

### Freezing:

In some instances, the biological sample (e.g., a tissue section as described above) can be prepared by deep freezing at a temperature suitable to maintain or preserve the integrity (e.g., the physical characteristics) of the tissue structure. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than −15° C., less than −20° C., or less than −25° C. In some instances, the biological sample can be from fresh frozen samples.

### Fixation and Post-Fixation:

In some instances, the biological sample can be prepared using formalin-fixation and paraffin-embedding (FFPE), which are established methods. In some instances, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some instances, acetone fixation is used with fresh frozen samples, which can include, but are not limited to, cortex tissue, mouse olfactory bulb, human brain tumor, human post-mortem brain, and breast cancer samples. When acetone fixation is performed, pre-permeabilization steps (described below) may not be performed. Alternatively, acetone fixation can be performed in conjunction with permeabilization steps.

In some instances, the methods provided herein comprises one or more post-fixing (also referred to as post-fixation) steps. In some instances, one or more post-fixing step is performed after contacting a sample with a polynucleotide disclosed herein, e.g., one or more probes such as a circular or circularizable probe. In some instances, one or more post-fixing step is performed after a hybridization complex comprising a probe and a target is formed in a sample. In some instances, one or more post-fixing step is performed prior to a ligation reaction disclosed herein, such as the ligation to circularize a probe.

In some instances, one or more post-fixing step is performed after contacting a sample with a binding or labelling agent (e.g., an antibody or antigen binding fragment thereof) for a non-nucleic acid analyte such as a protein analyte. The labelling agent can comprise a nucleic acid molecule (e.g., reporter oligonucleotide) comprising a sequence corresponding to the labelling agent and therefore corresponds to (e.g., uniquely identifies) the analyte. In some instances, the labelling agent can comprise a reporter oligonucleotide comprising one or more barcode sequences.

A post-fixing step may be performed using any suitable fixation reagent disclosed herein, for example, 3% (w/v) paraformaldehyde in DEPC-PBS.

### Embedding and Crosslinking:

As an alternative to paraffin embedding described above, a biological sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some instances, the biological sample can be embedded in a matrix (e.g., a hydrogel matrix). Embedding the sample in this manner typically involves contacting the biological sample with a hydrogel such that the biological sample becomes surrounded by the hydrogel. For example, the sample can be embedded by contacting the sample with a suitable polymer material, and activating the polymer material to form a hydrogel. In some instances, the hydrogel is formed such that the hydrogel is internalized within the biological sample.

In some instances, the biological sample is immobilized in the hydrogel via cross-linking of the polymer material that forms the hydrogel. Cross-linking can be performed chemically and/or photochemically, or alternatively by any other hydrogel-formation method known in the art. In some instances, analytes (e.g., protein, RNA, and/or DNA), polynucleotides added to the sample (e.g., probes) and/or products thereof, in the biological sample can be embedded in a 3D matrix. In some instances, one or more of the analytes, polynucleotides and/or products thereof can be modified to contain functional groups that can be used as an anchoring site to attach to the polymer matrix. In some aspects, the 3D polymer matrix can be a hydrogel. In some instances, hydrogel formation within a biological sample is reversible.

In some instances, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GelMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

The composition and application of the hydrogel-matrix to a biological sample typically depends on the nature and preparation of the biological sample (e.g., sectioned, non-sectioned, type of fixation). As one example, where the biological sample is a tissue section, the hydrogel-matrix can include a monomer solution and an ammonium persulfate (APS) initiator/tetramethylethylenediamine (TEMED) accelerator solution. As another example, where the biological sample consists of cells (e.g., cultured cells or cells disassociated from a tissue sample), the cells can be incubated with the monomer solution and APS/TEMED solutions. For cells, hydrogel-matrix gels are formed in compartments, including but not limited to devices used to culture, maintain, or transport the cells. For example, hydrogel-matrices can be formed with monomer solution plus APS/TEMED added to the compartment to a depth ranging from about 0.1 μm to about 2 mm. Additional methods and aspects of hydrogel embedding of biological samples are described for example in Chen et al., Science 347(6221):543-548, 2015, the entire contents of which are incorporated herein by reference.

Hydrogels embedded within biological samples can be cleared using any suitable method. For example, electrophoretic tissue clearing methods can be used to remove biological macromolecules from the hydrogel-embedded sample. In some instances, a hydrogel-embedded sample is stored before or after clearing of hydrogel, in a medium (e.g., a mounting medium, methylcellulose, or other semi-solid mediums).

In some instances, a method disclosed herein comprises de-crosslinking the reversibly cross-linked biological sample. The de-crosslinking does not need to be complete. In some instances, only a portion of crosslinked molecules in the reversibly cross-linked biological sample are de-crosslinked and allowed to migrate.

### Staining and Immunohistochemistry (IHC):

To facilitate visualization, biological samples can be stained using a wide variety of stains and staining techniques. In some instances, for example, a sample can be stained using any number of stains and/or immunohistochemical reagents. One or more staining steps may be performed to prepare or process a biological sample for an assay described herein or may be performed during and/or after an assay. In some instances, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some instances, cells in the sample can be segmented using one or more images taken of the stained sample.

In some instances, the stain is performed using a lipophilic dye. In some examples, the staining is performed with a lipophilic carbocyanine or aminostyryl dye, or analogs thereof (e.g, DiI, DiO, DiR, DiD). Other cell membrane stains may include FM and RH dyes or immunohistochemical reagents specific for cell membrane proteins. In some examples, the stain may include but is not limited to, acridine orange, acid fuchsin, Bismarck brown, carmine, coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine, or derivatives thereof. In some instances, the sample may be stained with haematoxylin and eosin (H&E).

The sample can be stained using hematoxylin and eosin (H&E) staining techniques, using Papanicolaou staining techniques, Masson's trichrome staining techniques, silver staining techniques, Sudan staining techniques, and/or using Periodic Acid Schiff (PAS) staining techniques. PAS staining is typically performed after formalin or acetone fixation. In some instances, the sample can be stained using Romanowsky stain, including Wright's stain, Jenner's stain, Can-Grunwald stain, Leishman stain, and Giemsa stain.

In some instances, biological samples can be destained. Methods of destaining or discoloring a biological sample are known in the art, and generally depend on the nature of the stain(s) applied to the sample. For example, in some instances, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

### Isometric Expansion:

In some instances, a biological sample embedded in a matrix (e.g., a hydrogel) can be isometrically expanded. Isometric expansion methods that can be used include hydration, a preparative step in expansion microscopy, as described in Chen, et al., Science 347(6221):543-548, 2015.

Isometric expansion can be performed by tethering (e.g, anchoring) one or more components of a biological sample to a gel, followed by gel formation, proteolysis, and swelling. In some instances, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some instances, the isometrically expanded biological sample can be removed from the substrate prior to contacting the substrate with probes disclosed herein.

In general, the steps used to perform isometric expansion of the biological sample can depend on the characteristics of the sample (e.g., thickness of tissue section, fixation, cross-linking), and/or the analyte of interest (e.g., different conditions to anchor RNA, DNA, and protein to a gel).

In some instances, proteins in the biological sample are anchored to a swellable gel such as a polyelectrolyte gel. An antibody can be directed to the protein before, after, or in conjunction with being anchored to the swellable gel. DNA and/or RNA in a biological sample can also be anchored to the swellable gel via a suitable linker. Examples of such linkers include, but are not limited to, 6-((Acryloyl)amino) hexanoic acid (Acryloyl-X SE) (available from ThermoFisher, Waltham, Mass.), Label-IT Amine (available from MirusBio, Madison, Wis.) and Label X (described for example in Chen, et al., Nat. Methods 13:679-684, 2016, the entire contents of which are incorporated herein by reference).

Isometric expansion of the sample can increase the spatial resolution of the subsequent analysis of the sample. The increased resolution in spatial profiling can be determined by comparison of an isometrically expanded sample with a sample that has not been isometrically expanded.

In some instances, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9× its non-expanded size. In some instances, the sample is isometrically expanded to at least 2× and less than 20× of its non-expanded size.

### Tissue Permeabilization and Treatment:

In some instances, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X-100™ or Tween-20™), and enzymes (e.g., trypsin, proteases). In some instances, the biological sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some instances, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some instances, the biological sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some instances, DNase and RNase inactivating agents or inhibitors such as proteinase K, and/or chelating agents such as EDTA, can be added to the sample. For example, a method disclosed herein may comprise a step for increasing accessibility of a nucleic acid for binding, e.g., a denaturation step to open up DNA in a cell for hybridization by a probe. For example, proteinase K treatment may be used to free up DNA with proteins bound thereto.

### Analytes

Reagents may be used to detect and/or analyze any different analytes may be detected or analyzed in the samples described herein. Any of the reactions and assays for processing, detecting and/or analyzing any different analytes can be performed in a flow cell or using a system described herein. In some aspects, an analyte can include any biological substance, structure, moiety, or component to be analyzed. In some aspects, a target may include any analyte of interest. In some instances, a target or an analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed. Such a specific binding partner may be a nucleic acid probe (for a nucleic acid analyte) and may lead directly to the generation of an RCA template (e.g., a padlock or other circularizable probe). Alternatively, the specific binding partner may be coupled to a nucleic acid, which may be detected using an RCA strategy, e.g., in an assay which uses or generates a circular nucleic acid molecule which can be the RCA template.

Analytes of particular interest may include nucleic acid molecules, such as DNA (e.g., genomic DNA, mitochondrial DNA, plastid DNA, viral DNA, etc.) and RNA (e.g., mRNA, microRNA, rRNA, snRNA, viral RNA, etc.), and synthetic and/or modified nucleic acid molecules, (e.g., including nucleic acid domains comprising or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which comprise a lipid or carbohydrate component. The analyte may be a single molecule or a complex that contains two or more molecular subunits, e.g., including but not limited to protein-DNA complexes, which may or may not be covalently bound to one another, and which may be the same or different. Thus in addition to cells or microorganisms, such a complex analyte may also be a protein complex or protein interaction. Such a complex or interaction may thus be a homo- or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

### Endogenous Analytes

In some instances, an analyte herein is endogenous to a sample (e.g., a biological sample) and can include nucleic acid analytes and non-nucleic acid analytes. Regents may be suitable for analyzing nucleic acid analytes (e.g., using a nucleic acid probe or probe set that directly or indirectly hybridizes to a nucleic acid analyte) and/or non-nucleic acid analytes (e.g., using a labelling agent that comprises a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some instances, an analyte may be a denatured nucleic acid, wherein the resulting denatured nucleic acid is single-stranded. The nucleic acid may be denatured, for example, optionally using formamide, heat, or both formamide and heat. In some instances, the nucleic acid is not denatured for use in a method disclosed herein.

In certain instances, an analyte can be extracted from a live cell. Processing conditions can be adjusted to ensure that a biological sample remains live during analysis, and analytes are extracted from (or released from) live cells of the sample. Live cell-derived analytes can be obtained only once from the sample or can be obtained at intervals from a sample that continues to remain in viable condition.

Any number of analytes may be measured within a sample. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In some instances, the analyte comprises a target sequence. In some instances, the target sequence may be endogenous to the sample, generated in the sample, added to the sample, or associated with an analyte in the sample. In some instances, the target sequence is a single-stranded target sequence (e.g., a sequence in a rolling circle amplification product). In some instances, the analytes comprise one or more single-stranded target sequences. In one aspect, a first single-stranded target sequence is not identical to a second single-stranded target sequence. In another aspect, a first single-stranded target sequence is identical to one or more second single-stranded target sequence. In some instances, the one or more second single-stranded target sequence is comprised in the same analyte (e.g., nucleic acid) as the first single-stranded target sequence. Alternatively, the one or more second single-stranded target sequence is comprised in a different analyte (e.g., nucleic acid) from the first single-stranded target sequence.

### Labelling Agents

Labeling agents may be used to analyze endogenous analytes (e.g., RNA, ssDNA, and cell surface or intracellular proteins and/or metabolites) in a sample described herein. In some instances, a labelling agent may include an agent that interacts with an analyte (e.g., an endogenous analyte in a sample). In some instances, the labelling agents can comprise a reporter oligonucleotide that is indicative of the analyte or portion thereof interacting with the labelling agent. For example, the reporter oligonucleotide may comprise a barcode sequence that permits identification of the labelling agent. In some instances, the sample contacted by the labelling agent can be further contacted with a probe (e.g., a single-stranded probe sequence), that hybridizes to a reporter oligonucleotide of the labelling agent, in order to identify the analyte associated with the labelling agent. In some instances, the analyte labelling agent comprises an analyte binding moiety and a labelling agent barcode domain comprising one or more barcode sequences, e.g., a barcode sequence that corresponds to the analyte binding moiety and/or the analyte. An analyte binding moiety barcode includes to a barcode that is associated with or otherwise identifies the analyte binding moiety. In some instances, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some instances, the method comprises one or more post-fixing (also referred to as post-fixation) steps after contacting the sample with one or more labelling agents.

In the methods and systems described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some instances, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may comprise a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some instances, an analyte binding moiety includes one or more antibodies or antigen binding fragments thereof. The antibodies or antigen binding fragments including the analyte binding moiety can specifically bind to a target analyte. In some instances, the analyte is a protein (e.g., a protein on a surface of the biological sample (e.g., a cell) or an intracellular protein). In some instances, a plurality of analyte labelling agents comprising a plurality of analyte binding moieties bind a plurality of analytes present in a biological sample. In some instances, the plurality of analytes includes a single species of analyte (e.g., a single species of polypeptide). In some instances in which the plurality of analytes includes a single species of analyte, the analyte binding moieties of the plurality of analyte labelling agents are the same. In some instances in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some instances, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some instances, these reporter oligonucleotides may comprise nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide comprising a barcode sequence that identifies the label agent. For instance, the labelling agent may be directly coupled (e.g., covalently bound) to a hybridization oligonucleotide that comprises a sequence that hybridizes with a sequence of the reporter oligonucleotide. Hybridization of the hybridization oligonucleotide to the reporter oligonucleotide couples the labelling agent to the reporter oligonucleotide. In some instances, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer binding sequence (such as an R1, R2, or partial R1 or R2 sequence).

In some cases, the labelling agent can comprise a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some instances, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent comprising an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

Products of Endogenous Analyte and/or Labelling Agent

In some instances, one or more products of an endogenous analyte and/or a labelling agent may be analyzed in a sample (e.g., a biological sample) described herein. In some instances, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product such as a rolling circle amplification (RCA) product) thereof is analyzed. In some instances, a labelling agent that directly or indirectly binds to an analyte in the biological sample is analyzed. In some instances, a product (e.g., a hybridization product, a ligation product, an extension product (e.g., by a DNA or RNA polymerase), a replication product, a transcription/reverse transcription product, and/or an amplification product such as a rolling circle amplification (RCA) product) of a labelling agent that directly or indirectly binds to an analyte in the sample (e.g., the biological sample) is analyzed.

### Hybridization and Ligation

Various probes and probe sets can be hybridized to an endogenous analyte and/or a labelling agent and each probe may comprise one or more barcode sequences. The specific probe or probe set design can vary. In some instances, the hybridization of a primary probe or probe set (e.g., a circularizable probe or probe set) to a target nucleic acid analyte and may lead to the generation of a rolling circle amplification (RCA) template. In some instances, the assay uses or generates a circular nucleic acid molecule which can be the RCA template.

In some instances, a product of an endogenous analyte and/or a labelling agent is a ligation product. In some instances, the ligation product is formed from circularization of a circularizable probe or probe set upon hybridization to a target sequence. In some instances, the ligation product is formed between two or more endogenous analytes. In some instances, the ligation product is formed between an endogenous analyte and a labelling agent. In some instances, the ligation product is formed between two or more labelling agent. In some instances, the ligation product is an intramolecular ligation of an endogenous analyte. In some instances, the ligation product is an intramolecular ligation of a labelling agent, for example, the circularization of a circularizable probe or probe set upon hybridization to a target sequence. The target sequence can be comprised in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some instances, provided herein is a probe or probe set capable of DNA-templated ligation, such as from a cDNA molecule. See, e.g., U.S. Pat. No. 8,551,710, which is hereby incorporated by reference in its entirety. In some instances, provided herein is a probe or probe set capable of RNA-templated ligation. See, e.g., U.S. Pat. Pub. 2020/0224244 which is hereby incorporated by reference in its entirety. In some instances, the probe set is a SNAIL probe set. See, e.g., U.S. Pat. Pub. 20190055594, which is hereby incorporated by reference in its entirety. In some instances, provided herein is a multiplexed proximity ligation assay. See, e.g., U.S. Pat. Pub. 20140194311 which is hereby incorporated by reference in its entirety. In some instances, provided herein is a probe or probe set capable of proximity ligation, for instance a proximity ligation assay for RNA (e.g., PLAYR) probe set. See, e.g., U.S. Pat. Pub. 20160108458, which is hereby incorporated by reference in its entirety. In some instances, a circular probe can be indirectly hybridized to the target nucleic acid. In some instances, the circular construct is formed from a probe set capable of proximity ligation, for instance a proximity ligation in situ hybridization (PLISH) probe set. See, e.g., U.S. Pat. Pub. 2020/0224243 which is hereby incorporated by reference in its entirety.

In some instances, the ligation involves chemical ligation. In some instances, the ligation involves template dependent ligation. In some instances, the ligation involves template independent ligation. In some instances, the ligation involves enzymatic ligation.

In some instances, the enzymatic ligation involves use of a ligase. In some aspects, the ligase used herein comprises an enzyme that is commonly used to join polynucleotides together or to join the ends of a single polynucleotide. An RNA ligase, a DNA ligase, or another variety of ligase can be used to ligate two nucleotide sequences together. Ligases comprise ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases comprise bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some instances, the ligase is a T4 RNA ligase. In some instances, the ligase is a splintR ligase. In some instances, the ligase is a single stranded DNA ligase. In some instances, the ligase is a T4 DNA ligase. In some instances, the ligase is a ligase that has an DNA-splinted DNA ligase activity. In some instances, the ligase is a ligase that has an RNA-splinted DNA ligase activity.

In some instances, the ligation herein is a direct ligation. In some instances, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some instances, said ends are not ligated directly to each other, but instead occurs either via the intermediacy of one or more intervening (so-called “gap” or “gap-filling” (oligo)nucleotides) or by the extension of the 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo)nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific implementations, the gap may be a gap of about 1, 2, 3, 4, 5, 6, 7, 8, 9, or 10 or more nucleotides, of any integer (or range of integers) of nucleotides in between the indicated values. In some instances, the gap between said terminal regions may be filled by a gap oligonucleotide or by extending the 3′ end of a polynucleotide. In some cases, ligation involves ligating the ends of the probe to at least one gap (oligo)nucleotide, such that the gap (oligo)nucleotide becomes incorporated into the resulting polynucleotide. In some instances, the ligation herein is preceded by gap filling. In other implementations, the ligation herein does not require gap filling.

In some instances, ligation of the polynucleotides produces polynucleotides with melting temperature higher than that of un-ligated polynucleotides. Thus, in some aspects, ligation stabilizes the hybridization complex containing the ligated polynucleotides prior to subsequent steps, comprising amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tm) of the DNA strands. This selectively reduces the concentration of annealed mismatched substrates (expected to have a slightly lower Tm around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

### Primer Extension and Amplification

In some instances, a product is a primer extension product of an analyte, a labelling agent, a probe or probe set bound to the analyte (e.g., a padlock probe bound to genomic DNA, mRNA, or cDNA), or a probe or probe set bound to the labelling agent (e.g., a padlock probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some instances, a product of an endogenous analyte and/or a labelling agent is an amplification product of one or more polynucleotides, for instance, a circular probe or circularizable probe or probe set. In some instances, the amplifying is achieved by performing rolling circle amplification (RCA). In other instances, a primer that hybridizes to the circular probe or circularized probe is added and used as such for amplification. In some instances, the RCA comprises a linear RCA, a branched RCA, a dendritic RCA, or any combination thereof.

In some instances, the amplification is performed at a temperature between or between about 20° C. and about 60° C. In some instances, the amplification is performed at a temperature between or between about 30° C. and about 40° C. In some instances, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some instances, upon addition of a DNA polymerase in the presence of appropriate dNTP precursors and other cofactors, a primer is elongated to produce multiple copies of the circular template. This amplification step can utilize isothermal amplification or non-isothermal amplification. In some instances, after the formation of the hybridization complex and association of the amplification probe, the hybridization complex is rolling circle amplified to generate a cDNA nanoball (i.e., amplicon) containing multiple copies of the cDNA. Techniques for rolling circle amplification (RCA) are known in the art such as linear RCA, a branched RCA, a dendritic RCA, or any combination thereof. (See, e.g., Baner et al, Nucleic Acids Research, 26:5073-5078, 1998; Lizardi et al, Nature Genetics 19:226, 1998; Mohsen et al., Acc. Chem. Res. 2016 Nov. 15; 49(11): 2540-2550; Schweitzer et al. Proc. Natl Acad. Sci. USA 97:101 13-1 19, 2000; Faruqi et al, BMC Genomics 2:4, 2000; Nallur et al, Nucl. Acids Res. 29:el 18, 2001; Dean et al. Genome Res. 1 1:1095-1099, 2001; Schweitzer et al, Nature Biotech. 20:359-365, 2002; U.S. Pat. Nos. 6,054,274, 6,291,187, 6,323,009, 6,344,329 and 6,368,801). Exemplary polymerases for use in RCA comprise DNA polymerase such phi29 (cp29) polymerase, Klenow fragment, Bacillus stearothermophilus DNA polymerase (BST), T4 DNA polymerase, T7 DNA polymerase, or DNA polymerase I. In some aspects, DNA polymerases that have been engineered or mutated to have desirable characteristics can be employed. In some instances, the polymerase is phi29 DNA polymerase.

In some aspects, during the amplification step, modified nucleotides can be added to the reaction to incorporate the modified nucleotides in the amplification product (e.g., nanoball). Exemplary of the modified nucleotides comprise amine-modified nucleotides. In some aspects, for example, for anchoring or cross-linking of the generated amplification product (e.g., nanoball) to a scaffold, to cellular structures and/or to other amplification products (e.g., other nanoballs). In some aspects, the amplification products comprises a modified nucleotide, such as an amine-modified nucleotide. In some instances, the amine-modified nucleotide comprises an acrylic acid N-hydroxysuccinimide moiety modification. Examples of other amine-modified nucleotides comprise, but are not limited to, a 5-Aminoallyl-dUTP moiety modification, a 5-Propargylamino-dCTP moiety modification, an N6-6-Aminohexyl-dATP moiety modification, or a 7-Deaza-7-Propargylamino-dATP moiety modification.

In some aspects, the polynucleotides and/or amplification product (e.g., amplicon) can be anchored to a polymer matrix. For example, the polymer matrix can be a hydrogel. In some instances, one or more of the polynucleotide probe(s) can be modified to contain functional groups that can be used as an anchoring site to attach the polynucleotide probes and/or amplification product to a polymer matrix. Exemplary modification and polymer matrix that can be employed in accordance with the provided instances comprise those described in, for example, WO 2014/163886, WO 2017/079406, US 2016/0024555, US 2018/0251833, and US 2017/0219465. In some examples, the scaffold also contains modifications or functional groups that can react with or incorporate the modifications or functional groups of the probe set or amplification product. In some examples, the scaffold can comprise oligonucleotides, polymers or chemical groups, to provide a matrix and/or support structures.

The amplification products may be immobilized within the matrix generally at the location of the nucleic acid being amplified, thereby creating a localized colony of amplicons. The amplification products may be immobilized within the matrix by steric factors. The amplification products may also be immobilized within the matrix by covalent or noncovalent bonding. In this manner, the amplification products may be considered to be attached to the matrix. By being immobilized to the matrix, such as by covalent bonding or cross-linking, the size and spatial relationship of the original amplicons is maintained. By being immobilized to the matrix, such as by covalent bonding or cross-linking, the amplification products are resistant to movement or unraveling under mechanical stress.

In some aspects, the amplification products are copolymerized and/or covalently attached to the surrounding matrix thereby preserving their spatial relationship and any information inherent thereto. For example, if the amplification products are those generated from DNA or RNA within a cell embedded in the matrix, the amplification products can also be functionalized to form covalent attachment to the matrix preserving their spatial information within the cell thereby providing a subcellular localization distribution pattern. In some instances, one or more polynucleotide probe sets and/or the amplification products may be embedded in the presence of hydrogel subunits to form one or more hydrogel-embedded amplification products. In some instances, the hydrogel-tissue chemistry described comprises covalently attaching nucleic acids to in situ synthesized hydrogel for tissue clearing, enzyme diffusion, and multiple-cycle sequencing while an existing hydrogel-tissue chemistry method cannot. In some instances, to enable amplification product embedding in the tissue-hydrogel setting, amine-modified nucleotides are comprised in the amplification step (e.g., RCA), functionalized with an acrylamide moiety using acrylic acid N-hydroxysuccinimide esters, and copolymerized with acrylamide monomers to form a hydrogel.

In some instances, the RCA template may comprise the target analyte, or a part thereof, where the target analyte is a nucleic acid, or it may be provided or generated as a proxy, or a marker, for the analyte. As noted above, many assays are known for the detection of numerous different analytes, which use a RCA-based detection system, e.g., where the signal is provided by generating a RCA product (RCP) from a circular RCA template which is provided or generated in the assay, and the RCP is detected to detect the analyte. The RCP may thus be regarded as a reporter which is detected to detect the target analyte. However, the RCA template may also be regarded as a reporter for the target analyte; the RCP is generated based on the RCA template and comprises complementary copies of the RCA template. The RCA template determines the signal, which is detected, and is thus indicative of the target analyte. As will be described in more detail below, the RCA template may be a probe, or a part or component of a probe, or may be generated from a probe, or it may be a component of a detection assay (i.e., a reagent in a detection assay), which is used as a reporter for the assay, or a part of a reporter, or signal-generation system. The RCA template used to generate the RCP may thus be a circular (e.g., circularized) reporter nucleic acid molecule, namely from any RCA-based detection assay which uses or generates a circular nucleic acid molecule as a reporter for the assay. Since the RCA template generates the RCP reporter, it may be viewed as part of the reporter system for the assay.

In some instances, a product includes a molecule or a complex generated in a series of reactions, e.g., hybridization, ligation, extension, replication, transcription/reverse transcription, and/or amplification (e.g., rolling circle amplification), in any suitable combination. For example, a product comprising a target sequence for a probe may be a hybridization complex formed of a cellular nucleic acid in a sample and an exogenously added nucleic acid probe. The exogenously added nucleic acid probe may comprise an overhang that does not hybridize to the cellular nucleic acid but hybridizes to another probe. The exogenously added nucleic acid probe may be optionally ligated to a cellular nucleic acid molecule or another exogenous nucleic acid molecule. In other examples, a product comprising a target sequence for a probe may be an RCP of a circularizable probe or probe set which hybridizes to a cellular nucleic acid molecule (e.g., genomic DNA or mRNA) or product thereof (e.g., a transcript such as cDNA, a DNA-templated ligation product of two probes, or an RNA-templated ligation product of two probes). In other examples, a product comprising a target sequence for a probe may a probe hybridizing to an RCP. The probe may comprise an overhang that does not hybridize to the RCP but hybridizes to another probe. The probe may be optionally ligated to a cellular nucleic acid molecule or another probe, e.g., an anchor probe that hybridize to the RCP.

### In Situ Methods

In some instances, specific reagents are added to a sample at one or more regions of interest for analysis by in situ methods. In situ methods include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present. In situ methods may be used to detect and or quantify nucleic acids in a biological sample spatially by performing the method on the sample at one or more regions of interest. In situ methods may include using one or more fluid sources to flow in one or more reagents sequentially to contact the sample, e.g., at the region of interest, performing a hybridization and/or a chemical reaction with a labeled oligonucleotide, and detecting the label. Additional steps are described in more detail below.

In some aspects, the methods provided herein of detecting and removing a bubble from a flow cell may be useful in an assay including a cyclic process for detecting analytes in a sample by providing and removing various reagents (e.g., probes, enzymatic reagents, chemical reagents). In some instances, the present disclosure relates to methods and compositions for detecting analytes in a temporally sequential manner for in situ analysis of an analyte in a biological sample, e.g., a target nucleic acid in a cell in an intact tissue. In some aspects, the analytes in the flow cell can be detected using detectably-labeled probes that generate a signal signature corresponding to an analyte of the plurality of analytes.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto. The label may be, e.g., an optical label, a molecular label (e.g., an antigen), a radiolabel, or a field attractable label (e.g., electric or magnetic). In some instances, the optical label is a fluorescent label, e.g., as used in fluorescence in situ hybridization (FISH). A fluorescent label can be detected by routine optical detection methods known in the art, e.g., employing the imaging devices and methods described herein.

Optical detection, e.g., via the imaging devices and methods described herein, may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a sample (e.g., a biological sample; e.g., a biological tissue sample). The biological sample may be immobilized, e.g., in a flow cell. The sample may be permeabilized by adding a fluid, such as a solvent (e.g., acetone and methanol) or a detergent (e.g., TRITON® X-100, NP-40, TWEEN® 20, saponin, digitonin, and Leucoperm), to the sample. Permeabilization may allow or enhance access of the probes for the intracellular space of the sample.

A probe may then be added to the sample, e.g., by flowing a fluid containing the probe through the inlet, to contact the biological sample (e.g., the sample medium containing the biological sample), e.g., at the region of interest. The probe hybridizes to the target, e.g., an mRNA. Any unbound probes may be washed away by flowing another fluid lacking the probe through the sample, e.g., via the inlet. The fluid containing the unbound probes may be removed from the sample, e.g., at region of interest, through the outlet of the device.

In some instances, a plurality of probes is used, e.g., for ease of detection and/or signal amplification. For example, a first probe may include a nucleic acid sequence that hybridizes to a target nucleic acid in the sample. A secondary probe that includes a label (e.g., optical label, e.g., fluorescent label) may then be added that hybridizes to the first probe. In some instances, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some instances, the signal or template target nucleic acid is amplified, e.g., by polymerase chain reaction (PCR) or rolling circle amplification (RCA). The target nucleic acid may be replicated, e.g., by using the probe as a primer to initiate DNA or RNA synthesis. In such an instance, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some instances, the signal is increased by using a plurality of different probes that hybridize to the same nucleic acid, e.g., at a different sequential location. For example, an RNA transcript may contain a hybridization region for a plurality of (e.g., 2, 3, 4, 6, 7, 8, 9, 10, 15, 20, 25, 30, 35, 40, 45, 50, or more) probes. Each probe or a secondary probe that hybridizes to the primary probe may contain a detectable label. This allows the plurality of labels all present on the same RNA to produce a detectable signal.

The macromolecular components (e.g., bioanalytes) of individual samples (e.g., biological samples (e.g., cells or tissues)) can be identified or detected with unique identifiers (e.g., barcodes) such that upon characterization of those macromolecular components, such that any given component (e.g., bioanalyte) may be traced to the biological sample (e.g., cell) from which it was obtained. The ability to attribute characteristics to individual biological samples or groups of biological samples is provided by the assignment of unique identifiers specifically to an individual biological sample or groups of biological samples. Unique identifiers, for example, in the form of nucleic acid barcodes, can be assigned or associated with individual biological samples (e.g., cells) or populations of biological samples (e.g., cells), or genes (e.g., mRNA transcripts, in order to tag or label the biological sample's macromolecular components (and as a result, its characteristics) with the unique identifiers. These unique identifiers can then be used to attribute the biological sample's components and characteristics to an individual biological sample or group of biological samples.

In some aspects, the unique identifiers are provided in the form of oligonucleotides that comprise nucleic acid barcode sequences that may be attached to or otherwise associated with the nucleic acid contents of individual biological sample, or to other components of the biological sample, and particularly to fragments of those nucleic acids.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Moieties (e.g., oligonucleotides) can also include other functional sequences useful in processing of nucleic acids from biological samples, e.g., contained in a droplet. These sequences include, for example, targeted or random/universal amplification primer sequences for amplifying the genomic DNA from the individual biological samples within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

Reagents may also include molecular labels. The molecular labels may include barcodes (e.g., nucleic acid barcodes). The molecular labels can be provided to the biological sample based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with cells or particulate components of interest. The lipophilic moiety may insert into the plasma membrane of a cell thereby labeling the cell with the barcode. The devices and methods described herein may result in molecular labels being present on (i) the interior of a cell or particulate component and/or (ii) the exterior of a cell or particulate component (e.g., on or within the cell membrane). These and other suitable methods will be appreciated by those skilled in the art (see U.S. Pub. Nos. US20190177800, US20190323088, US20190338353, and US20200002763, each of which is incorporated herein by reference in its entirety).

### Kits

Devices described herein may be combined with various external components, e.g., detectors, pumps, reservoirs, flow cells, controllers, one or more sensors (e.g., one or more lenses (e.g., tube lens), microscope objectives, lasers, spectrometers, etc.), liquid handlers, reagents, liquids (e.g., reagent liquids and/or washing liquids), instrumentation, or computing devices (e.g., computer) in the form of kits. Kits may include devices and components of systems described herein. Kits may also provide instructions for using the devices and/or systems described herein.

FIG. 1A shows an exemplary device operatively coupled with a closed flow cell (101). In various embodiments, a first fluidic switch (106) is positioned along an inlet channel (108) to the closed flow cell (101). In various embodiments, the first fluidic switch (106) is positioned before a flow cell inlet connection (104) of the closed flow cell (101). In various embodiments, a second fluidic switch (111) is positioned along an outlet channel (112) from the closed flow cell (101). In various embodiments, the second fluidic switch (111) is positioned after a flow cell outlet connection (105) of the closed flow cell (101). In various embodiments, one or more bypass channel(s) (109) fluidically connects the first fluidic switch (106) to the second fluidic switch (111). In various embodiments, the first fluidic switch (106) includes an actuatable valve configured to actuate between a first position allowing flow into the flow cell inlet connection (104) and a second position allowing flow into the bypass channel (109) (and preventing flow into the flow cell inlet connection (104)). In various embodiments, the second fluidic switch (111) includes an actuatable valve configured to actuate between a first position allowing flow from the flow cell outlet connection (105) to the flow cell outlet channel (112) and a second position allowing flow from the bypass channel (109) to the flow cell outlet channel (112) (and preventing flow from the flow cell outlet connection (105)). In various embodiments, the first fluidic switch (106) and second fluidic switch (111) are actuated at about the same time in response to a bubble being detected. In various embodiments, the first fluidic switch (106) is actuated before the second fluidic switch (111) is actuated. In various embodiments, the first fluidic switch (106) is actuated in response to the first sensor (107) detecting the presences of a bubble flowing in the channel. In various embodiments, the second fluidic switch (111) is actuated in response to the first sensor (107) detecting the presences of a bubble flowing in the channel. In various embodiments, the second fluidic switch (111) is actuated in response to the second sensor (110) detecting the presences of a bubble flowing in the channel.

In various embodiments, the one or more bypass channels includes two or more channels in parallel. In various embodiments, the one or more bypass channels include two or more channels in series. In various embodiments, each of the two or more channels includes the same dimensions (e.g., radius, height, width, length, etc.). In various embodiments, the two or more channels include different dimensions. For example, a plurality of bypass channels (e.g., two, three, four, five, six, etc.) can be provided in parallel where each additional bypass channel has a larger dimension than a previous bypass channel. In various embodiments, the one or more bypass channels include a taper (e.g., taper to larger dimensions, taper to smaller dimensions, have multiple tapers in an hourglass shape or inverse hourglass shape, etc.). In various embodiments, the one or more bypass channels have the same dimensions as the inlet and/or outlet channels. In various embodiments, the one or more bypass channels have different dimensions (e.g., are larger, are smaller) than the inlet and/or outlet channels depending on desired bypass channel flow rate(s). In various embodiments, the inlet channel (108) includes a first sensor (107) (e.g., an optical sensor for detecting the presence of bubbles). In various embodiments, the one or more bypass channels (109) include a second sensor (110) (e.g., an optical sensor for detecting the presence of bubbles). In various embodiments, the optical sensor is configured to detect transmission of one or more wavelengths of light (e.g., a range of wavelengths) through a channel. For example, the transmission of light may have a first value when fluid is flowing through the channel and a second value (different from the first value) when a bubble is present between the light emitter and light detector due to, e.g., a change in the optical index of flow medium. In various embodiments, the first sensor (107) and/or second sensor (110) includes a sensor array (e.g., CMOS sensor). In various embodiments, the first sensor (107) and/or second sensor (110) includes an infrared sensor. In various embodiments, the first sensor (107) and/or second sensor (110) includes an ultrasonic sensor. In various embodiments, the first sensor (107) and/or second sensor (110) includes a light emitting diode and photodetector positioned with the channel therebetween. In various embodiments, the first sensor (107) and/or second sensor (110) includes a capacitive sensor.

FIG. 1B shows an exemplary device operatively coupled with a closed flow cell (113). A first fluidic switch (118) can either place the flow cell inlet channel (120) in fluid communication with the bypass channel (121) and waste channel and/or reservoir (124) or place the flow cell inlet channel (120) in fluid communication with the flow cell (113) and flow cell outlet channel (123).

FIGS. 2A-2D illustrate steps for preventing the introduction of a bubble (201) into a closed flow cell (202) using the device exemplified in FIG. 1A. FIG. 2A illustrates a bubble (201) flowing along the flow cell inlet channel (203) prior to passing by the first sensor (204). As shown in FIG. 2B, the bubble (201) is at the first sensor (204), which detects the bubble (201) prior to the introduction of the bubble (201) into the flow cell (202). In various embodiments, upon detection of the bubble (201), the first fluidic switch (205) is actuated to thereby cause the flow cell inlet channel (203) to be in fluid communication with the bypass channel (206) and also restrict flow into the flow cell inlet connection (207). As shown in FIG. 2C, the bubble (201) is directed into the bypass channel (206), and the second sensor (208) detects the bubble (201). As shown in FIG. 2D, the first and second fluidic switches (205, 209) are actuated to put the flow cell inlet channel (203) in fluid communication with the flow cell (202) and the flow cell outlet channel (210), thereby trapping the bubble (201) in the bypass channel (206). In various embodiments, the bubble (201) is allowed to pass through the second fluidic switch (209) and into the flow cell outlet channel (210) before the second fluidic switch (209) actuates back to allow the flow cell outlet connection (211) to be in fluid communication with the flow cell outlet channel (210).

FIGS. 3A-3C illustrate steps for removing a bubble (303) detected in a flow cell (304) by using a washing liquid to wash the bubble (303) out of the flow cell (304). As shown in FIG. 3A, a sensor (302) (e.g., an optical sensor) detects a bubble (303) in a flow cell (304). In various embodiments, the optical sensor (302) is a camera sensor (e.g., CMOS). In various embodiments, the optical sensor (302) includes one or more optical components, such as an objective lens, a tube lens, a fold mirror, etc., configured to image the flow cell (304) and process the image to thereby detect the presence of a bubble (303). As shown in FIG. 3B, the washing fluidic switch (301) actuates to allow the washing channel (305) to be in fluid communication with the flow cell (304), and the washing liquid flows through the flow cell (304) to wash out the bubble (303). As shown in FIG. 3C, once the bubble (303) has been washed out, the washing fluidic switch (301) actuates back so that the first channel (306) is in fluid communication with the flow cell (304). In various embodiments, after the bubble (303) has been washed out of the flow cell (304), one or more reagent liquids flow into and/or through the flow cell (304) (which may have a biological sample disposed therein).

### EXAMPLE

The following example is included for illustrative purposes only and is not intended to limit the scope of the present disclosure.

### Example 1: Debubbling in a Flow Cell for In Situ Detection of Signals Corresponding to Target Nucleic Acid Molecules

This example discloses exemplary workflows that improve target detection assays and image analysis (e.g., for an in situ analysis system). Analysis and detection of target analytes may be performed in flow cells (e.g., closed flow cells), and bubbles may be introduced into flow cells during fluid exchange for the assays, for example, due to initial priming, reagent degassing, temperature change, reagent delivery, washing, reagent extraction, etc. Any bubbles within the flow cell chamber in which the sample is contained may interfere with reactions by preventing or reducing contact of reagents and samples and/or introduce imaging artifacts. In some cases, if a bubble is introduced into a flow cell with a sample (e.g., a tissue sample), a region of the sample may no longer be in contact with liquid reagent, causing local assay failure. While introducing high flow rates to the flow cell may remove bubbles, this approach uses a large volume of reagent and introduces high shear forces on a sample within the flow cell which may damage the sample (e.g., tissue samples). This example illustrates performing an assay using a device for reducing or removing bubbles in flow cells.

A biological sample (102 or 114) (e.g., a processed or cleared biological sample, a tissue sample, a sample embedded in a hydrogel, etc.) is provided in a closed flow cell (101 or 113) that is coupled to an exemplary device as depicted in FIG. 1A or 1B. In some examples as shown in FIG. 1A, the device includes a first fluidic switch (106) and a second fluidic switch (111) that can either place the flow cell inlet channel (108) and the flow cell outlet channel (112) in fluid communication with the bypass channel (109) or place the flow cell inlet channel (108) in fluid communication with the flow cell (101) (e.g., for probe and other reagent delivery) and the flow cell outlet channel (112). In some examples as shown in FIG. 1B, the flow cell inlet channel (120) can be in fluid communication with the bypass channel (109) and waste channel and/or reservoir (124) or place the flow cell inlet channel (120) in fluid communication with the flow cell (113) and flow cell outlet channel (123). The flow cell inlet channel (108 or 120) may be in fluid connection with a reagent reservoir.

The sample is contacted with a plurality of probes via the flow cell inlet channel that hybridize to different target sequences of target nucleic acid molecules, e.g., mRNA. Each probe includes a hybridization region that hybridizes to a target sequence on the target nucleic acid and at least one barcode region, which facilitates generation of a detectable signal. Labeled (e.g., fluorophore-labeled) detectable probes can be delivered to the sample in the flow cell, which hybridizes to the one or more barcode regions. The sample is imaged to detect and quantify the number and/or location of the target nucleic acid molecules based on a signal associated with the detectable probe. The delivery of probes can be repeated to generate a signal signature corresponding to an analyte of the plurality of analytes in the sample.

During any of the reagent (e.g., probe) delivery or other assay steps, a bubble may be introduced into the flow cell. The first sensor (204) detects the bubble (small solid circle; 201) as shown in FIGS. 2A-2B, and the first and second fluidic switches (205; 209) are actuated to put the flow cell inlet channel (203) and flow cell outlet channel (210) in fluid communication with the bypass channel (206). The bubble (201) is directed into the bypass channel (206) as shown in FIG. 2C. The second sensor (208) detects the bubble (201) as shown in FIG. 2C, and the first and second fluidic switches (205; 209) are actuated to put the flow cell inlet channel (203) in fluid communication with the flow cell (202) and the flow cell outlet channel (210) as shown in FIG. 2D. After removal of the bubble (201), the assay may resume and deliver other assay reagents (e.g., probes).

In some cases, if a bubble (303) is detected in a flow cell (304), a washing liquid is used to wash the bubble (303) out of the flow cell (304) as shown in FIGS. 3A-3C. If a sensor (e.g., an optical sensor; 302) detects a bubble (303) in a flow cell (304) (FIG. 3A), the washing fluidic switch (301) puts the washing channel (305) in fluid communication with the flow cell (304), and the washing liquid flows through the flow cell (304) to wash out the bubble (303) (FIG. 3B). Once the bubble (303) has been washed out, the washing fluidic switch (301) puts the first channel (306) in fluid communication with the flow cell (304), and the reagent liquid flows through the flow cell (304).

Using the systems described, an assay can be performed in a flow cell in a manner which prevents bubbles from entering the flow cell and interrupting with the assay (FIGS. 1A-1B and FIGS. 2A-2C), and/or remove bubbles if any enter into the flow cell (FIGS. 3A-3C).

The present invention is not intended to be limited in scope to the particular disclosed embodiments, which are provided, for example, to illustrate various aspects of the invention. Various modifications to the compositions and methods described will become apparent from the description and teachings herein. Such variations may be practiced without departing from the true scope and spirit of the disclosure and are intended to fall within the scope of the present disclosure.

1. A device comprising:
(i) a flow cell inlet connection,
(ii) a flow cell outlet connection,
(iii) a flow cell inlet channel,
(iv) a flow cell outlet channel,
(v) a first sensor,
(vi) a second sensor,
(vii) a first fluidic switch, and
(viii) a bypass channel,
wherein the first fluidic switch directs flow from the flow cell inlet channel into either the flow cell inlet connection or the bypass channel, the flow cell outlet connection is in fluid communication with the flow cell outlet channel, the first sensor is disposed to detect a bubble upstream of the first fluidic switch, and the second sensor is disposed to detect the bubble in the bypass channel.

2. The device of claim 1, wherein the bypass channel is passively or actively in fluid communication with the flow cell outlet channel.

3. The device of claim 2, further comprising a second fluidic switch that directs flow from the flow cell outlet connection or the bypass channel into the flow cell outlet channel.

4. The device of claim 1, further comprising a waste channel or reservoir in fluid communication with the bypass channel.

5. The device of claim 1, wherein the first and second sensors are optical sensors.

6. (canceled)

7. A system comprising the device of claim 1, wherein the device further comprises a flow cell having an inlet in fluid communication with the flow cell inlet connection and an outlet in fluid communication with the flow cell outlet connection, and wherein the system further comprises a fluidic pump configured to pump liquid into the flow cell.

8-11. (canceled)

12. The system of claim 7, further comprising an imaging device or imaging system disposed to image the flow cell.

13-14. (canceled)

15. A system comprising:
(a) a device of claim 1, wherein the device further comprises a flow cell having an inlet in fluid communication with the flow cell inlet connection and an outlet in fluid communication with the flow cell outlet connection,
wherein the first fluidic switch directs flow from the flow cell inlet channel into either the flow cell inlet connection or the bypass channel, the flow cell outlet connection is in fluid communication with the flow cell outlet channel, the first sensor is disposed to detect a bubble upstream of the first fluidic switch, and the second sensor is disposed to detect the bubble in the bypass channel; and
(b) a switch controller for controlling the first switch,
wherein the switch controller is configured to receive an input from the first sensor, whereby upon detection of a bubble by the first sensor, the switch controller actuates the first fluidic switch to place the flow cell inlet channel in fluid connection with the bypass channel, and wherein the switch controller is configured to receive an input from the second sensor, whereby upon detection of the bubble by the second sensor, the switch controller actuates the first fluidic switch to place the flow cell inlet channel in fluid connection with the flow cell inlet connection.

16. The system of claim 15, wherein the device further comprises a second fluidic switch that directs flow from the flow cell outlet connection or the bypass channel into the flow cell outlet channel, and wherein the switch controller is further configured for controlling the second fluidic switch.

17-19. (canceled)

20. The system of claim 15, further comprising an imaging device or imaging system disposed to image the flow cell.

21-22. (canceled)

23. A method of controlling flow in a flow cell comprising:
(a) providing a device comprising:
a flow cell inlet connection,
a flow cell outlet connection,
a flow cell inlet channel,
a flow cell outlet channel,
a first sensor,
a second sensor,
a first fluidic switch,
a bypass channel, and
a flow cell having an inlet in fluid communication with the flow cell inlet connection and an outlet in fluid communication with the flow cell outlet connection;
wherein the first fluidic switch directs flow from the flow cell inlet channel into either the flow cell inlet connection or the bypass channel, the flow cell outlet connection is in fluid communication with the flow cell outlet channel, the first sensor is disposed to detect a bubble upstream of the first fluidic switch, and the second sensor is disposed to detect the bubble in the bypass channel; and
(b) flowing a reagent liquid in the flow cell inlet channel, wherein the first fluidic switch directs flow into the flow cell via the flow cell inlet connection, wherein, upon detection of a bubble by the first sensor, the first fluidic switch directs flow into the bypass channel, wherein after detection of the bubble by the second sensor, the first fluidic switch directs flow to the flow cell.

24. The method of claim 23, further comprising:
(c) detecting the bubble with the first sensor; and
(d) actuating the first fluidic switch so that the flow cell inlet channel is in fluid communication with the bypass channel.

25. The method of claim 24, further comprising:
(e) detecting the bubble with the second sensor; and
(f) actuating the first fluidic switch so that the flow cell inlet channel is in fluid communication with the flow cell.

26. The method of claim 23, further comprising:
(c) detecting the bubble with the first sensor; and
(d) actuating the first and second fluidic switches so that the flow cell inlet channel is in fluid communication with the bypass channel and the bypass channel is in fluid communication with the flow cell outlet channel.

27. The method of claim 26, further comprising:
(e) detecting the bubble with the second sensor; and
(f) actuating the first and second fluidic switches so that the flow cell inlet channel is in fluid communication with the flow cell and the flow cell outlet channel.

28. A method of removing a bubble from a flow cell comprising:
(a) providing a flow cell having an inlet in fluid communication with the flow cell inlet connection and an outlet in fluid communication with the flow cell outlet connection, wherein the flow cell inlet intersects a first channel and a washing channel at a first intersection comprising a washing fluidic switch, wherein the washing fluidic switch controls whether the flow cell inlet is in fluid communication with the first channel or the washing channel;
(b) providing a first sensor disposed to detect a bubble in the flow cell;
(c) flowing a reagent liquid into the flow cell via the washing fluidic switch;
(d) upon the first sensor detecting a bubble, actuating the washing fluidic switch so that the flow cell inlet is in fluid communication with the washing channel; and
(e) flowing a washing liquid through the flow cell to remove the bubble.

29. The method of claim 28, further comprising:
(f) actuating the washing fluidic switch so that the flow cell inlet is in fluid communication with the first channel; and
(g) flowing the reagent liquid through the flow cell.

30-33. (canceled)

34. The method of claim 28, wherein the washing liquid is more hydrophilic than the reagent liquid.

35. The method of claim 28, wherein the washing liquid comprises an alcohol.

36-37. (canceled)

38. The method of claim 28, wherein the washing liquid comprises a surfactant.

39-40. (canceled)
